(19) United States
(12) Patent Application Publication
(10) Pub. No.: US 2020/0392288 A1
(43) Pub. Date: Dec. 17, 2020

(54) ANTI-FOGGING PROTEINOIDS AND COMPOSITION COMPRISING SAME

(71) Applicant: BAR-ILAN UNIVERSITY, Ramat Gan (IL)

(72) Inventors: Shlomo MARGEL, Rehovot (IL); Michal KOLITZ DOMB, Petah Tikva (IL); Elisheva SASON, Petah Tikva (IL)

(21) Appl. No.: 16/766,689

(22) PCT Filed: Nov. 22, 2018
(86) PCT No.: PCT/IL2018/051269

§ 371 Date: May 24, 2020

Related U.S. Application Data
(60) Provisional application No. 62/590,302, filed on Nov. 23, 2017.

(51) Int. Cl. C08G 69/10; C08G 69/04; B05D 3/06

(52) U.S. Cl. CPC C08G 69/10; C08L 33/08; B05D 3/067; C08G 69/04

(57) ABSTRACT

Anti-fogging proteinoid compounds are disclosed. Processes of preparing the antifogging proteinoid compositions and incorporating thereof in or on a substrate are also disclosed. Articles of manufacturing incorporating such compositions are also disclosed.

### CROSS REFERENCE TO RELATED APPLICATIONS

This application claims the benefit of priority to U.S. Provisional Patent Application No. 62/590,302 filed Nov. 23, 2017, the contents of which are incorporated herein by reference in their entirety.

### FIELD OF THE INVENTION

The present invention relates, in some embodiments thereof, to anti-fogging proteinoid compounds, compositions comprising same, processes of preparing such compositions and uses thereof.

### BACKGROUND

Proteinoids comprise poly(amino acid) prepared by thermal random condensation polymerization of various α-amino acids.

Fog appears when moisture condenses on a hydrophobic surface and is drawn into tiny droplets that scatter light. The scattering of the light gives the surface the appearance of a fog. Hydrophilic surfaces, on the other hand, will absorb the condensed moisture into the surface preventing the tiny light scattering droplets from forming. However, at some point the hydrophilic surface may reach saturation of the moisture, thus resulting in the formation of light scattering water droplets on the surface and resulting in poor anti-fog coatings. Other factor may also affect the fog appearance, such as surface smoothness.

Coatings that reduce the tendency for surfaces to “fog up” have been reported. These so-called anti-fog coatings improve the wettability of a surface by allowing a thin layer of water film to form on the surface instead of discrete droplets. Known anti-fog coatings include, for example, coatings using ammonium soap, such as mixtures of an alkyl ammonium carboxylates with a surface active agent, for example, a sulfated or sulfonated fatty material; salts of sulfated alkyl aryloxypolyalkoxy alcohol; or alkylbenzene sulfonates. Other common anti-fog coating compositions use colloidal silica to provide water resistance. However, colloidal silica coating compositions generally have a high solvent content and are generally less effective for controlling condensation. Other common anti-fog compositions require chemical crosslinking to form a cohesive film.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### SUMMARY OF THE INVENTION

The present invention relates, in some embodiments thereof, to anti-fogging proteinoid compounds, compositions comprising same, processes of preparing such compositions and uses thereof.

According to an aspect of some embodiments, there is provided a composition comprising a substrate having incorporated in and/or on a portion thereof at least one proteinoid compound, the at least one proteinoid compound comprising a polymeric backbone, wherein the polymeric backbone comprises monomeric units, each of the monomeric units being derived from an amino acid, and wherein the polymeric backbone is characterized by a molecular weight (Mw) of at least 5,000 Da.

According to an aspect of some embodiments, there is provided a composition comprising: (i) at least one proteinoid compound comprising a polymeric backbone, wherein the polymeric backbone comprises monomeric units, each of the monomeric units being derived from an amino acid, and wherein the polymeric backbone is characterized by a molecular weight (Mw) of at least 5,000 Da, and (ii) at least one proteinoid compound further encapsulates or is attached to solid surfaces or to at least one antifogging agents.

According to an aspect of some embodiments, there is provided a composition comprising: a) at least one proteinoid compound, the at least one proteinoid compound comprising i) a polymeric backbone, wherein the polymeric backbone comprises monomeric units, each of the monomeric units being derived from an amino acid, and wherein the polymeric backbone is characterized by a molecular weight (Mw) of at least 5,000 Da, and ii) a at least one activated double bond, at least one primary amine, or a combination thereof; and b) a crosslinker.

In some embodiments, the disclosed composition of any of the embodiments comprises an acrylate polymer.

In some embodiments, the acrylate polymer has an average molecular weight in the range of 200 Da to 1000 Da.

In some embodiments, the crosslinker comprises a diacrylate monomer, triacrylate monomer or a combination thereof.

In some embodiments, the disclosed composition of any of the embodiments further comprising a photo-initiator.

In some embodiments, the disclosed composition of any of the embodiments comprises a plurality of the proteinoid compounds.

In some embodiments, the amino acid is, in each instance, selected from the group consisting of: Glu, Lys, Asp, Arg, Tyr, His, Ala, Ser, Trp and Phe, Ile, and p-amino benzoic acid.

In some embodiments, the polymeric backbone comprises Glu or Lys.

In some embodiments, the polymeric backbone further comprises Phe.

In some embodiments, the polymeric backbone further comprises Glu or Lys, and Phe and/or Ile and/or His and/or Trp and/or Ser.

In some embodiments, the Glu or Lys is at least 20%, by weight, of the polymeric backbone.

In some embodiments, the proteinoid compound is in form of a particle.

In some embodiments, at least 80% of the plurality of the proteinoid compounds are characterized by a dispersity index (D) value of less than 1.5.

In some embodiments, at least one proteinoid compound further encapsulates or is attached to solid surfaces or to an antifogging agent.

In some embodiments, the antifogging agent is selected from the group consisting of: sorbitan monooleate (SMO), glycerol monooleate (GMO), glyceryl monostearate, sorbitan monolaurate, sorbitan monostearate, sorbitan trioleate, sorbitan polyethylene oxide, sorbitan monopalmitate, polyoxyethylene sorbitan monolaurate, fatty acid ester of sucrose and any combination thereof.

In some embodiments, the substrate is a polymeric material. In some embodiments, polymeric material is selected from the group consisting of polypropylene (PP), polycarbonate (PC), polyethylene (PE), high-density polyethylene (HDPE), polyester (PE), polyethylene terephthalate (PET), polyvinyl chloride (PVC), polystyrene, polymethyl methacrylate and polytetrafluoroethylene (PTFE, Teflon®).

In some embodiments, the substrate further comprises on at least a portion thereof an adhesive material.

In some embodiments, the proteinoid compound is deposited on, or incorporated in at least one portion of the adhesive material. In some embodiments, the adhesive material is imine.

In some embodiments, the composition is characterized by a liquid contact angle of less than 100°. In some embodiments, the liquid is water and the contact angle is in the range of 5° to 70°. In some embodiments, the liquid is water and the contact angle is in the range of 3° to 70°.

In some embodiments, the composition is characterized by a RMS roughness having a value of at least 30% lower than a RMS roughness of a portion of a control surface, the control surface not having deposited thereon the proteinoid compound.

According to an aspect of some embodiments, there is provided an article-of-manufacturing comprising the disclosed composition. In some embodiments, the article-of-manufacturing is selected from the group consisting of sealing part, for example, O-rings, article having a corrosivable surface, a construction element, and an optical article.

According to an aspect of some embodiments, there is provided a method of reducing water contact angle on a surface of a substrate, the method comprising applying one or more proteinoid compounds on the surface.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1B present graphs showing the hydrodynamic diameters of P(EI) (FIG. 1A) and P(EI)-10% SMO (FIG. 1B);

FIGS. 2A-2C present atomic force microscopy (AFM) images of oxygen pre-treated polypropylene (PP-t) (FIG. 2A), PP film coated with poly(L-glutamic acid-L-phenylalanine), P(EF), (FIG. 2B), and PP film coated with poly(L-glutamic acid-L-Isoleucine), P(EI), (FIG. 2C); and

FIGS. 3A-3D present photographs illustrating optical visibility ranking: transparent continuous layer of water, excellent optical performance (FIG. 3A; denoted as “A”); large water drops on some parts of the surface allowing partial light transition (FIG. 3B; denoted as “B”); medium water drops on most of the surface allowing partial light transition (FIG. 3C; denoted as “C”); small water drops on the whole surface, causing very poor visibility (FIG. 3D; denoted as “D”);

FIG. 4 presents a scheme of a Michael addition reaction of a proteinoid with TEGDA. The reaction was done at 50° C. and stirred for 120 min;

FIG. 5 presents a photograph illustrating a Mayer rod coating setup for coating on to plastic films. The PET plastic film is put on a flat surface and the Mayer rod is pulled over the mixture of film former or proteinoid with film former, which leaves a uniform layer with wet thicknesses of 6 μm;

FIGS. 6A-6F present graphs showing FT-IR spectra of PET (FIGS. 6A and 6D), PET/PEGDA 400 before (FIGS. 6B and 6E) and after (FIG. 6C, F) UV curing. FIG. 6A, B and C are full spectra; FIG. 6D, E and F are high resolution spectra of 1700-1500 cm⁻¹;

FIGS. 7A-7E present contact angle images of corona-treated PET film: uncoated (FIG. 7A), coated with film former A2 (FIG. 7B), P(KI)A2 (FIG. 7C), P(EI)A2 (FIG. 7D) and P(KF)A2 (FIG. 7E);

FIGS. 8A-8D: presents photographs illustrating hot fog test after 1 h in 60° C. of uncoated PET (FIG. 8A,B) and P(KI)A2 (FIG. 8C,D);

### DETAILED DESCRIPTION OF THE INVENTION

The present invention, in some embodiments thereof, relates, inter alia, to proteinoid compounds characterized by a molecular weight (Mw) of at least 5,000 Da, to processes of preparing such compounds and to uses thereof.

The principles and operation of the proteinoid compounds, compositions, use, methods and processes according to the invention may be better understood with reference to the drawings and accompanying descriptions as disclosed herewith.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As demonstrated in the Examples section, deposition of proteinoids on variable substrates resulted in imparting antifogging properties to the substrate's surface.

The Compositions and Articles

In some embodiments of the present invention, there is provided a composition-of-matter comprising a substrate and one or more proteinoid compounds.

In some embodiments of the present invention, there is provided a composition comprising at least one proteinoid compound, the at least one proteinoid compound comprising i) a polymeric backbone, wherein the polymeric backbone comprises monomeric units, each of the monomeric units being derived from an amino acid, and wherein the polymeric backbone is characterized by a molecular weight (Mw) of at least 5,000 Da, and ii) a at least one activated double bond, at least one primary amine, or a combination thereof and a crosslinker.

In some embodiments, a crosslinker comprises an acrylate polymer. In some embodiments, a crosslinker comprises a hydrophilic acrylate polymer. In some embodiments, a crosslinker comprises a diacrylate monomer, triacrylate monomer or a combination thereof In some embodiments, a crosslinker comprises glycol diacrylate (PEGDA), triethylene glycol, ethylene glycol dimethacrylate (EGDMA), or any combination thereof

In some embodiments, an acrylate polymer has an average molecular weight in the range of 200 Da to 1000 Da. In some embodiments, an acrylate polymer has an average molecular weight in the range of 300 Da to 1000 Da, 400 Da to 1000 Da, 500 Da to 1000 Da, 600 Da to 1000 Da, 200 Da to 900 Da, or 200 Da to 800 Da, including any range therebetween.

In some embodiments, a glycol diacrylate (PEGDA) has an average molecular weight in the range of 200 Da to 1000 Da. In some embodiments, a glycol diacrylate (PEGDA) has an average molecular weight in the range of300 Da to 1000 Da, 400 Da to 1000 Da, 500 Da to 1000 Da, 600 Da to 1000 Da, 200 Da to 900 Da, or 200 Da to 800 Da, including any range therebetween.

In some embodiments, a composition according to the present invention, further comprising a photo-initiator.

In some embodiments, a proteinoid compound having at least one activated double bond was prepared via a Michael addition reaction. In some embodiments, a proteinoid compound having at least one activated double bond was prepared via a Michael addition reaction between a proteinoid compound as described elsewhere herein and excess of a diacrylate.

In some embodiments, the proteinoid compounds are in a weight percent of at least 0.5.

In some embodiments, the one or more proteinoids are characterized as having antifogging properties.

In some embodiments the weight percent is 0.5, 1, 1.5, 2, 2.5, 3, 3.5, 4, 4.5, 5, 5.5, 6, 6.5, 7, 7.5, 8, 8.5, 9, 9.5, 10, 15, 20, 25, 30, 35, 40, 45, or 50, 70, 90, 99, including any value therebetween.

The proteinoids are described hereinbelow under “The Poteinoids” section hereinbelow. In exemplary embodiments the proteinoids comprise amino acids selected from glutamic acid, phenylalanine and isoleucine.

In some embodiments, the proteinoids are in form of particles.

In some embodiments, the proteinoids (e.g., proteinoids in form of particles) having anti-fogging properties are dissolved or dispersed in organic solvent(s). Nonlimiting examples of organic solvents are described hereinbelow.

In some embodiments, there is provided a composition comprising the proteinoids and one or more antifogging agents being attached to or encapsulated within the proteinoids.

Non-limiting examples of antifogging agents are described hereinbelow under “The Poteinoids” section. In this respect, it is to note that the antifogging properties may be promoted by the antifogging agents and/or by the proteinoid compounds per se. That is, in some embodiments, and as further exemplified in the Example section, the proteinoid compounds disclosed herein may promote the antifogging properties without the aid of an antifogging agents.

In some embodiments, there is provided an article-of-manufacturing (also referred to as “article”) comprising a substrate having incorporated therein or on at least one surface or a portion thereof one or more proteinoids.

In some embodiments, the article-of-manufacturing includes a sealing part, for example, O-rings, and the like.

In some embodiments, the article-of-manufacturing is, for example, article having a corrosivable surface.

In some embodiments, the article-of-manufacturing is an agricultural device. In some embodiments, the article of manufacture is a construction element, such as, but not limited to, paints, walls, windows, door handles, and the like.

In some embodiments, the article of manufacture according to the invention may be any optical article that may encounter a problem of fog formation, such as a screen, a glazing for the automotive industry or the building industry, or a mirror, it is preferably an optical lens, more preferably an ophthalmic lens, for spectacles, or a blank for optical or ophthalmic lenses.

The term “anti-fog compound”, and the like are used herein to indicate a compound that is capable of providing antifogging properties on at least one portion thereof. In the context of proteinoid compounds deposited on or incorporated within a substrate, this term is meant to refer to the antifogging properties being imparted on at least one surface of the substrate.

As noted hereinabove, in some embodiments, the proteinoid itself possess antifogging properties.

By “antifogging properties” it is meant to refer, inter alia, to the capability of a substrate's surface to prevent water vapor from condensing onto its surface in the form of small water drops redistributing them in the form of a continuous film of water in a very thin layer.

In some embodiments of the invention, the composition or article disclosed herein exhibit an increased antifogging effect with time.

In some embodiments of the invention, the composition or article disclosed herein are characterized by temperature-dependent antifogging properties. In some embodiments, the antifogging properties do not change significantly with time, when maintained both at room temperature, at elevated temperatures (e.g., 70-90° C.) and at lower temperatures (e.g., −30° C.).

In some embodiments, the composition or article disclosed herein exhibit antifogging properties that last for at least e.g., 1 h, 2 h, 3 h, 4 h, 5 h, 10 h, 1 day, 2 days, 3 days, 4 days, 5 days, or even several months.

In some embodiments, the composition or article disclosed herein exhibit an effect of reduced roughness with time.

Antifogging properties may be characterized visually as described in the Examples section, or may be characterized or measured by one or more methods known in the art and/or described hereinbelow. Antifogging properties may be characterized by e.g., roughness, contact angle, haze and gloss or by a combination thereof.

In some embodiments, the article-of-manufacturing is characterized as having anti-fog surface.

In some embodiments, the article is antifog optical article.

As used herein, an “antifog optical article” is intended to mean an optical article provided with an “antifog coating”.

Hereinthroughout, the expression “substrate having applied (or deposited) on a surface or apportion thereof” is also referred to herein, for simplicity, as a coated substrate, a coated surface, a coated sample, a substrate or surface having a film deposited thereon, and as varying combination of the above expressions, and all of these expressions are referred to herein interchangeably. In some embodiments, the proteinoid compound or the composition according to any one of the respective embodiments is incorporated in and/or on at least a portion of the substrate.

By “a portion” it is meant to refer to, for example, a surface or a portion thereof, and/or a body or a portion thereof, of solid or semi-solid substrates; or a volume or a part thereof, of liquid, gel, foams and other non-solid substrates.

The term “one or more proteinoids” refers to and a plurality of proteinoid compounds or particles, as described in any of the respective embodiments.

Substrates of widely different chemical nature can be successfully utilized for incorporating (e.g., depositing on a surface thereof) the compounds or particles thereon, as described herein. By “successfully utilized” it is meant that (i) the compounds or particles as described herein successfully form a uniform and homogenously coating on the substrate's surface; and (ii) the resulting coating imparts long-lasting desired properties (e.g., anti-fog properties) to the substrate's surface.

Herein the term “coating” and any grammatical derivative thereof, is defined as a coating that (i) is positioned above the substrate/coating, (ii) is not necessarily in contact with the substrate/coating, that is to say one or more intermediate coatings may be arranged between the substrate/coating and the coating in question (however, it may be in contact with the substrate/coating), and (iii) does not necessarily completely cover the substrate/coating.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); polymeric surfaces such as, for example, plastic surfaces, rubbery surfaces, paper, wood, fabric in a woven, knitted or non-woven form, mineral (rock or glass), surfaces, wool, silk, cotton, hemp, leather, fur, feather, skin, hide, pelt or pelage surfaces, plastic surfaces and surfaces comprising or made of polymers such as but not limited to polypropylene (PP), polymethylmethacrylate (PMMA), polycarbonate (PC), polyethylene (PE), high-density polyethylene (HDPE), polyester (PE), polyethylene terephthalate (PET), unplasticized polyvinyl chloride (PVC), nylons, inorganic polymers such as silicon rubber or glass and fluoropolymers including but not limited to polytetrafluoroethylene (PTFE, Teflon®); or can comprise or be made of any of the foregoing substances, or any mixture thereof.

The substrate may be any number of substrates, porous, and non-porous substrates. By non-porous it is meant that a substrate does not have pores sufficient to significantly increase the bonding of the coating to the unprimed substrate. Non-porous substrates are selected from but are not limited to polymers of polycarbonate, polyesters, nylons, and metallic foils such as aluminum foil, with nylons and metallic foils.

In some embodiments, the substrate is hydrophobic. In some embodiments, the substrate is hydrophilic.

In some embodiments, the one or more proteinoids are directly applied on the substrate's surface. In some embodiments, the one or more proteinoids are non-directly applied on the substrate's surface. In some embodiments, the term “non-directly” is meant to refer to a substrate's surface that has a layer arranged under a layer of the proteinoid compounds. When a layer (referred to as “layer 1”) is arranged under another layer (referred to as “layer 2”), it is intended to mean that layer 2 is more distant from the substrate's surface than layer 1.

In some embodiments, the proteinoid compounds are mixed with the adhesive material prior to their deposition or incorporation in/on the substrate's surface.

In some embodiments, the substrate is a film composed of polypropylene, polyethylene or polyethylene terephthalate (denoted as PP, PE and PET, respectively), or a combination thereof. In some embodiments the substrate or film are pre-treated, e.g., oxygen plasma pre-treated as noted hereinbelow. In some embodiments the substrate or film are pre-treated prior to deposition of an adhesive layer and/or the proteinoids. In exemplary embodiments the PP is pre-treated with oxygen plasma (denoted as “PP-t”).

Herein, by “non-directly applied on the substrate's surface” it is meant that at least e.g., 60%, 70%, 80%, or 90% of proteinoid (e.g., proteinoid particles) coating are in form of non-direct contact with the substrate. By “non-direct contact” it is meant that the substrate has directly applied on a surface thereof an adhesive layer (layer 1), and the proteinoids are deposited on a surface of the adhesive layer.

The term “adhesive layer” or “adhesive material”, as used herein, refers to one or more regions of an adhesive composition or a primer (e.g., imine primer, polyvinyl alcohol/acetate, methyl cellulose, etc.) that has been formulated or processed so as to be substantially solid, coherent, and non-flowable. The adhesive layer may comprise a single continuous region a barrier layer. In some embodiments, “adhesive layer” intended to mean both an adhesive film, typically flat and of constant and/or even thickness, and an adhesive layer of varying and/or uneven thickness.

In some embodiments, the primer is dissolved in one or more organic solvents.

In some embodiments, the proteinoid compounds are mixed with the adhesive material prior to their deposition or incorporation in/on the substrate's surface so as to allow forming one layer comprising both proteinoid compounds and adhesive material.

Non-limiting examples of adhesive layers/materials comprise acrylic acid, methacrylic acid, acrylic ester, methacrylic ester, hydroxyalkylacrylate, hydroxyalkylmethacrylate, or mixtures of these, copolymers of vinylpyrrolidone or vinyl alcohol and acrylic acid or methacrylic acid.

In exemplary embodiments, the adhesive material is an imine primer. In some embodiments, the imine is polyethylenimine (e.g., A131-X). The polyethylenimine may allow improved adhesion of the proteinoids or particles thereof to the substrate.

The substrate may be primed with the imine primer by any conventional and known-in-the-art method of priming such as those methods used for priming substrates with water-based primers. An example of a suitable method of priming the substrate is by spraying.

In some embodiments, the substrate is in form of a film. The term “film” refers to a flat or tubular structure e.g., a sheet having substantially greater area than thickness.

As further demonstrated in the Examples section, roughness measurements have shown a substantial decrease in the roughness of the surface of the substrates upon proteinoid deposition, compared to non-treated substrates.

As demonstrated in the Example section the surface of the substrate is characterized by nanoscale roughness.

The term “roughness” as used herein relates to the irregularities in the surface texture. Irregularities are the peaks and valleys of a surface.

In some embodiments, roughness value is computed by methods known in the art, e.g., AA (arithmetic average) and RMS (root-mean-square). The AA method uses the absolute values of the deviations in the averaging procedure, whereas the RMS method utilizes the squared values of the deviations in the averaging process.

In some embodiments, the surface is characterized by a RMS roughness of at least 20% lower than a RMS roughness of the surface of the substrate (before incorporating the proteinoid compounds). In some embodiments, the surface is characterized by a RMS roughness of at least 30% lower than a RMS roughness of the surface of the substrate (before incorporating the proteinoid compounds). In some embodiments, the surface is characterized by a RMS roughness of at least 50% lower than a RMS roughness of the surface of the substrate (before incorporating the proteinoid compounds). In some embodiments, the surface is characterized by a RMS roughness of at least 100% lower than a RMS roughness of the surface of the substrate (before incorporating the proteinoid compounds). In some embodiments, the surface is characterized by a RMS roughness of at least 200% lower than a RMS roughness of the surface of the substrate (before incorporating the proteinoid compounds). In some embodiments, the surface is characterized by a RMS roughness of at least 300% lower than a RMS roughness of the surface of the substrate (before incorporating the proteinoid compounds). In some embodiments, the surface is characterized by a RMS roughness of at least 400% lower than a RMS roughness of the surface of the substrate (before incorporating the proteinoid compounds). In some embodiments, the surface is characterized by a RMS roughness of at least 500% lower than a RMS roughness of the surface of the substrate (before incorporating the proteinoid compounds). In some embodiments, the surface is characterized by a RMS roughness of at least 700% lower than a RMS roughness of the surface of the substrate (before incorporating the proteinoid compounds).

In some embodiments, the degree of the antifogging property is correlated with the wettability of a surface. Wettability of a surface is typically and acceptably determined by contact angle measurements of aqueous liquids, as is further detailed in the Example section hereinbelow.

Typically, a substrate's surface is considered wettable when it exhibits a static contact angle of less than e.g., 70°, 60°, 50°, 40°, 30°, 20°, 10°, 9°, 8°, 7°, 6°, or 5°, with an aqueous liquid.

In some embodiments, the film coated with the proteinoids is characterized by a contact angle, having a value of e.g., 90%, 80%, 70%, 60%, 50%, 40%, 30%, 20%, 10%, 5%, or 1%, of the contact angle of a control material (e.g., non-coated substrate).

The proteinoids may be deposited on various surfaces by methods known in the art, e.g., spreading, spray coating, dip coating methodologies, and that such methodologies result in hydrophilic surfaces, having a water contact angle less than e.g., 70°, 60°, 50°, 40°, 30°, 20°, 10°, 9°, 8°, 7°, 6°, or 5°.

In some embodiments, a substrate is heated prior to deposit of the proteinoids on the substrate. In some embodiments, the substrate is heated to a temperature that allows the softening of the substrate. In some embodiments, proteinoids are heated prior to deposit on a substrate.

In some embodiments, an organic solvent is added to the proteinoid prior to deposit of the proteinoids on a substrate. In some embodiments, an organic solvent is added to the substrate prior to deposit of the proteinoids on the substrate. In some embodiments, an organic solvent softens the surface of a substrate.

In some embodiments, an organic solvent is a solvent that can be easily evaporated.

In some embodiments, the organic solvent(s), suspension, or solution comprise, without being limited thereto, methyl ethyl ketone, toluene, butyl acetate, ethanol, isopropanol, or any mixture or combination thereof, e.g., a mixture of methyl ethyl ketone and toluene, a mixture of methyl ethyl ketone and butyl acetate, ethanol, isopropanol.

In some embodiments, the film coated with the proteinoids is characterized by a contact angle in the range of 3° to 70°. In some embodiments, the film coated with the proteinoids is characterized by a contact angle in the range of 3.5° to 70°, 4° to 70°, 4.5° to 70°, 4.9° to 70°, 5° to 70°, 3° to 50°, 3° to 40°, or 3° to 35°, including any range therebetween.

In exemplary embodiments, the substrate is coated using Mayer rode process.

In some embodiments, the substrate is co-extruded with proteinoids. In some embodiments, the substrate is co-extruded with 1%, 2%, 3%, 4%, 5%, 6%, 7%, 8%, 9%, 10%, or 20%, 30% proteinoids, by weight, including any value therebetween.

As used herein and in the art, the expressions “hydrophobic”, “hydrophobicity” and grammatical derivatives thereof, refer to a property reflected by water repellency. As noted hereinabove, the degree of hydrophobicity or hydrophilicity is typically and acceptably determined by contact angle measurements of water or aqueous solutions, or of amphiphilic liquid substances (e.g., glycerol and alkylene glycols).

Typically, a substrate's surface is considered hydrophobic when it exhibits a static water contact angle of at least 90° with water. A substrate's surface is considered hydrophilic when it exhibits a static water contact angle of lower than 90° with water.

As further shown in the Example section, in some embodiments, the antifogging property is characterized by haze measurements e.g., by recording percentages of haze values over a selected period of time.

In some embodiments, the coated substrate is characterized by transparency and/or optical properties such as high gloss and low haze. In some embodiments, the transparency of the coated substrate is substantially not affected by the prtoteinoid compositions/compounds, compared to the same substrate which does not have the proteinoid compositions/compounds applied e.g., on a surface thereof.

In some embodiments, the substrate is a lens having at least one surface region of a wettability property different from surrounding regions of the lens material, thereby preventing fogging of the lens within at least one surface region.

In some embodiments, the film coated with the proteinoids is characterized by haze, having a value of less than e.g., 99%, 95%, 90%, 80%, 70%, 60%, 50%, 40%, or 30%, of the haze of a control material (e.g., non-coated substrate).

In some embodiments, the film coated with the proteinoids is characterized by gloss having a value of e.g., 10%, 15%, 20%, 25%, 30%, 35%, or 40%, higher than the gloss of a control material (e.g., non-coated substrate).

In some embodiments, the substrates may comprise further materials such as: salts, stabilizers, plastisizers amnd processing aids.

Stabilizers retard degradation reactions during processing due to e.g., elevated temperatures generated and are well-known. Generally organometallic salts based on tin, lead, barium-cadmium, calcium and zinc are useful, including dibutyltinbeta-mercaptopropionate, dibutyltin maleate, barium, cadmium and/or lead stearate complexes. The stabilizers act primarily to neutralize the volatiles formed as decomposition products during processing of polymers such as the PVC resins, particularly hydrogen chloride vapor. Thus, an amount of stabilizer may be added to be just sufficient to prevent hydrogen chloride evolution. In some embodiments, from about 1 to 3 percent by weight of the total composition of one or more of the stabilizers is employed.

Plasticizers may be added to impart flexibility to to provide a lower melt viscosity to the mixture (as described hereinbelow) during the processing. This reduces the internal friction. Commonly employed plasticizers include phthalate, phosphate, adipate and azelate esters, as well as epoxidized soybean oil having a molecular weight of about 1000. Chlorinated paraffin waxes can also be used. The amount of plasticizer employed depends on the rigidity required in the final product and may be as high as 75% of the weight of resin.

Processing aids are added to increase the melt strength during processing to reduce the melt viscosity and elasticity of the composition or article. Commonly employed processing aids include, but not limited to, styrene-acrylonitrile resins and methylmethacrylate copolymers such as polymethylmethacrylate resins. The amount of processing aid added may be in the range of e.g., from 2% to 10% of the total molding composition.

According to an aspect of some embodiments of the present invention, there is provided a method of reducing water contact angle on a surface of a substrate, the method comprising applying at least one proteinoid compound or composition comprising one or more proteinoid compounds on the surface. As used herein, the term “reducing” in the context of contact angle on a surface of a substrate, indicates that the contact angle is essentially is reduced by at least 20%, at least 30%, at least 40%, at least 50%, at least 60%, at least 70%, at least 80%, at least 90%, including any value therebetween, compared to the same substrate which does not have the proteinoid compositions applied on a surface thereof.

Alternatively, the term “reducing” means a reduction to at least 15%, 10% or 5%. In some embodiments, as described herein, other properties such as: roughness, haze, gloss are affected by the composition disclosed herein including any value therebetween.

The Proteinoids

According to an aspect of some embodiments of the present invention, there is provided a proteinoid compound comprising a polymeric backbone, wherein the polymeric backbone comprises monomeric units, each of the monomeric units being derived from an amino acid, and wherein the polymeric backbone is characterized by a molecular weight (Mw) of at least 5,000 Da.

Proteinoid are known in the art as being prepared by a thermal condensation reaction from chosen amino acids, such as by synthetic or man-made reactions. Typically, proteinoids lack a defined secondary structure or tertiary structure. One skilled in the art will appreciated that proteinoids are not naturally occurring polypeptides.

The term “condensation reaction”, also referred to in the art as “step-growth process”, and the like, means reaction to form a covalent bond between organic functional groups possessing a complementary reactivity relationship, e.g., electrophile-nucleophile. Typically, the process may occur by the elimination of a small molecule such as water or an alcohol. Additional information may be found in G. Odian, Principles of Polymerization, 3rd edition, 1991, John Wiley & Sons: New York, p. 108.

As used hereinthroughout, the term “polymer” describes an organic substance composed of a plurality of repeating structural units (backbone units) covalently connected to one another.

The proteinoid compound may be water-soluble or water-insoluble. In some embodiments, the polymers are water soluble at a defined temperature range e.g., at room temperature, at 20° C. to 80° C., or at 50° C. to 100° C. The term “water-soluble”, or “soluble”, as used herein, means the nature with which a proteinoid is not easily precipitated in an aqueous solution and does not easily form inclusion bodies or other aggregates.

The proteinoid compound can further be charged polymers or non-charged polymers. Charged polymers can be cationic polymers, having positively charged groups and a positive net charge at a physiological pH; or anionic polymers, having negatively charged groups and a negative net charge at a physiological pH. Non-charged polymers can have positively charged and negatively charged group with a neutral net charge at physiological pH, or can be non-charged.

In some embodiments, the proteinoid compound has a weight average molecular weight (Mw) in the range of 5,000 Da to 200 kDa. In some embodiments, the polymer has Mw lower than 60 kDa. In some embodiments, the polymer's weight average molecular weight range is 15 to 60 kDa.

In some embodiments, the proteinoid compound has a weight average molecular weight (Mw) of at least 5,000 Da. In some embodiments, the proteinoid compound has a weight average molecular weight (Mw) of at least 8,000 Da, at least 8,500 Da, at least 9,000 Da, at least 9,500 Da, at least 10,000 Da, or at least 10,500 Da, including any value therebetween.

In some embodiments, the proteinoid compound has a weight average molar mass (M.) of at least 5,000 Da, at least 8,000 Da, at least 8,500 Da, at least 9,000 Da, at least 9,500 Da, at least 10,000 Da, or at least 10,500 Da, including any value therebetween.

In some embodiments, the proteinoid compound has a weight average molecular weight (Mw) in the range of 5,000 Da to 200 kDa, 9,000 Da to 200 kDa, 10,000 Da to 200 kDa, 12,000 Da to 200 kDa, 11,000 Da to 200 kDa, 8,000 Da to 60 kDa, 9,000 Da to 60 kDa, 10,000 Da to 60 kDa, 12,000 Da to 60 kDa, 11,000 Da to 60 kDa, 9,000 Da to 40 kDa, 9,000 Da to 40 kDa, or 9,000 Da to 20 kDa, including any range therebetween.

In some embodiments, the proteinoid compound has a weight average molar mass (M.) in the range of 5,000 Da to 200 kDa, 9,000 Da to 200 kDa, 10,000 Da to 200 kDa, 12,000 Da to 200 kDa, 11,000 Da to 200 kDa, 8,000 Da to 60 kDa, 9,000 Da to 60 kDa, 10,000 Da to 60 kDa, 12,000 Da to 60 kDa, 11,000 Da to 60 kDa, 9,000 Da to 40 kDa, 9,000 Da to 40 kDa, or 9,000 Da to 20 kDa, including any range therebetween.

As used herein, the term “molecular weight” encompasses any one of the average weight values selected from: Mn (Number average molar mass), NAMW (Number Average Molecular Weight), Mw (Mass average molar mass), WAMW (Weight Average Molecular Weight), Mz (Z average molar mass), My (Viscosity average molar mass), and MWCO (molecular weight cut-off). Unless stated otherwise this term refers to Mw.

The polymeric backbone is derived from, or corresponds to an amino acid.

By “derived from, or corresponds to an amino acid” it is meant to refer to amino acid residue.

The term “amino acid” (or “amino acids” or “amino acid type(s)”) is understood to include, without being limited thereto, the twenty naturally occurring amino acids, as known in the art. Furthermore, unless stated otherwise, the term “amino acid” may refer to both D- and L-amino acids. Non-conventional or modified amino acids (e.g., synthetic), are also conceivable some embodiments of the invention, including, for example, para-amino benzoic acid.

In some embodiments, the polymeric backbone is co-polymer, comprising, in each instance, the amino acid is selected from the group consisting of: Glu, Lys, Asp, Arg, Tyr, Ala, Ile, Ser, Trp and Phe.

The term “co-polymer” as used herein, refers to a polymer of at least two chemically distinct monomers.

In some embodiments, the polymeric backbone further comprises polyester.

Non-limiting examples of polyester which may be used include: aliphatic polyesters, cop oly (ether-esters), poly orthoesters, polyoxaesters, poly amidoesters, polyoxaesters containing amine groups, α,ω-hydroxyl, carboxyl compounds, poly(lactic-co-glycolic acid) and combinations thereof.

Additional non-limiting examples of polyester include: polylactide, polyglycolide, polycaprolactone, polyhydroxyalkanoate.

In exemplary embodiments, the polyester is polylactic acid (PLA) e.g., poly(L-lactic acid denoted hereinthroughout as “PLLA”). Without being bound by any particular theory, it is to note that the incorporation of the polyester in the backbone of the proteinoids may result to in the formation of a smaller hydrodynamic size of proteinoid (e.g., proteinoid particles) dispersed in aqueous solution and/or highly degradable proteinoid due to the increased hydrophobicity nature of the proteinoinds.

Herein, the term “polyester” is also meant to include one monomeric unit, or oligomer comprising more than one monomeric unit, from which the corresponding polymeric backbone may, or is, derived from. That is, in some embodiments, the polymeric backbone of the proteinoid comprises 1, 2, 3, 4, 5, 6, 7, 8, 9, 10, or more, monomeric units correspond to, or are derived from, polyester. In some embodiments, at least one monomeric unit corresponds to, or derived from polyester is not linked to another monomeric unit corresponds to, or derived from, polyester.

In some embodiments, the polymeric backbone of the proteinoid is represented by the following formula (I) also termed hereinthroughout as “acid proteinoid”:

[A₁]ₓ[A₂]_{y}[A₃]_{z}[A₄]

wherein:

A₁ is, in each instance, selected from Glu and Lys;

A₂, and A₃ are each, independently, a monomeric unit derived from an amino acid or are each, independently, absent;

A₄ represents a backbone corresponding to, or derived from, polyester.

In some embodiments, the polyester is absent;

x, y, and z are integers, independently, representing the total numbers of A₁, A₂, and A₃, respectively, in the polymeric backbone, such that x+y+z has a value of at least 100.

For example, a proteinoid comprising aspartic acid may comprise 2 to 100 aspartic acid residues. Therefore, such proteinoid may comprise e.g., 2, 3, 4, 5, 6, 7, 8, 9, 10, 11, 12, 13, 14 15, 16, 17, 18, 19, 20, 25, 30, 35, 40, 45, 50, 55, 60, 65, 70, 75, 80, 85, 90, 95, 100 aspartic acids etc.

Exemplary types of proteinoid compounds are disclosed hereinthroughout under “The Process”.

In some embodiments, the polyester is at least 1%, 2%, 3%, 4%, 5%, 6%, 7%, 8%, 9%, 10%, 11%, 12%, 13%, 14%, 15%, 16%, 17%, 18%, 19%, 20%, including any value therebetween, by weight, of the polymeric backbone.

In exemplary embodiments, the amino acid in formula I is selected from the group consisting of: Asp, Lys, Arg, and Phe.

In some embodiments, A₁ is Glu, A₂ is Phe and A₃ is absent.

In some embodiments, A₁ is Glu, A₂ is Phe and A₃ is Ile.

In some embodiments, A₁ is Lys, A₂ is Phe and A₃ is Ile.

In some embodiments, A₁ is Glu being at least 10%, 15%, 20%, 25%, or 30%, by weight, of the polymeric backbone. In some embodiments, A₁ is Lys being at least 10%, 15%, 20%, 25%, or 30%, by weight, of the polymeric backbone.

In still further exemplary embodiments, A₁ is Glu, A₂ is Asp, and A₃ is selected from the group consisting of: Lys, Phe, or is absent.

In still further exemplary embodiments, A₁ is Glu, A₂ is Lys, and A₃ is absent.

In still further exemplary embodiments, A₁ is Glu, A₂ is Lys, and A₃ is Phe.

In exemplary embodiments, the proteinoids comprise poly(L-glutamic acid-L-phenylalanine), poly(L-glutamic acid-L-Isoleucine) or poly(L-glutamic acid-L-phenylalanine-L-Isoleucine) (denoted as “(P)EF”, “(P)EI” and “(P)EFI”, respectively).

In some embodiments, there is provided a composition-of-matter comprising a plurality of the disclosed proteinoid compounds.

In some embodiments, at least e.g., 50%, 60%, 70%, 80%, 90% or 99% of plurality of the disclosed proteinoid compounds is characterized by a low dispersity index (D).

In some embodiments, at least 80% of the plurality of proteinoid compounds are characterized by a dispersity index (D) value of less than 1.5. In some embodiments, at least 80% of the plurality of the proteinoid compounds are characterized by a dispersity index (D) value of less than 1.4, less than 1.3, less than 1.2, less than 1.1, or less than 1.05, including any value therebetween.

In some embodiments, at least 80% of the plurality of the proteinoid compounds are characterized by a dispersity index (D) value in the range of 1 to 1.6. In some embodiments, at least 80% of the plurality of the proteinoid compounds are characterized by a dispersity index (D) value in the range of 1 to 1.5, 1 to 1.4, 1 to 1.3, 1 to 1.2, 1 to 1.1, 1 to 1.05, 1 to 1.03, or 1 to 1.02, including any range therebetween.

As used herein, “dispersity index”, also termed in the art: “polydispersity index” (denoted hereinthroughout as: “D”) refers to a measure of the distribution of molecular mass in a given polymer sample. The dispersity index is calculated by dividing the weight average molecular weight (Mw) by the number average molecular weight (Mn). As used herein, the term “weight average molecular weight” generally refers to a molecular weight measurement that depends on the contributions of polymer molecules according to their sizes. As used herein, the term “number average molecular weight” generally refers to a molecular weight measurement that is calculated by dividing the total weight of all the polymer molecules in a sample with the total number of polymer molecules in the sample. These terms are known by those of ordinary skill in the art.

D has a value always greater than 1, but as the polymer chains approach uniform chain length, the value of D approaches unity (1).

As used herein “low D value” refers to a value below 1.6. For example a “low D value” may be 1.59, 1.58, 1.57, 1.56, 1.55, 1.54, 1.53, 1.52, 1.51, 1.5, 1.49, 1.48, 1.47, 1.46, 1.45, 1.44, 1.43, 1.42, 1.41, 1.4, 1.39, 1.38, 1.37, 1.36, 1.35, 1.34, 1.33, 1.32, 1.31, 1.3, 1.29, 1.28, 1.27, 1.26, 1.25, 1.24, 1.26, 1.25, 1.24, 1.23, 1.22, 1.21, 1.2, 1.19, 1.18, 1.17, 1.16, 1.15, 1.14, 1.13, 1.12, 1.11, 1.1, 1.09, 1.08, 1.07, 1.06, 1.05, 1.04, 1.03, 1.02, 1.01, or 1.005, including any value therebetween.

In some embodiments, D may be further reduced by increasing the %, of the polyester in the proteinoid compound.

In some embodiments, a plurality of proteinoid compounds is characterized by a narrow size distribution of the proteinoids

As described hereinthroughout, and without being bound by any particular theory, the narrow size distribution of the proteinoids (including proteinoid-polyester compounds) dictates the formation of narrower size distribution of nano or micro-proteinoid particles, as described hereinbelow, via a self-assembly process.

In some embodiments, at least one proteinoid is in form of hollowsphere.

As used herein the term “hollowsphere”, or “proteinoid hollowsphere”, refers to any polymer having at least one void space in the primary polymeric structure. The term hollowsphere is used only for the purpose of illustration and it is to be construed that is not only limited to spherical shape but also includes any shape which may find suitability to at least some embodiments of the present invention. By “void space” herein it is meant to refer to a polymer-free space or a central cavity, typically filled with water e.g., in aqueous dispersion or with air in the dried hollowsphere.

In the context of the current disclosure, groups on the proteinoid may result in the generation of a hydrophobic core inside of the hollow sphere.

In some embodiments, the proteinoids are dissolved in an aqueous solution. In some embodiments, the proteinoids may become insoluble e.g., via a self-assembly process. In some embodiments, the proteinoids are characterized by the hydrophobic part being within the core of the hollowsphere and the hydrophilic residues being exposed towards the aqueous solution.

In some embodiments, the hollowsphere is characterized by a hydrophilic shell.

In some embodiments, the hollowsphere is characterized by a hydrophilic shell and a hydrophobic core.

In some embodiments, there is provided a composition comprising one or more proteinoid compounds and one or more antifogging agents as described hereinabove. In some embodiments, the one or more antifogging agents are attached to or encapsulated in the preoteinoid compounds, as described hereinthroughout.

In some embodiments, the antifogging agent is attached to a surface of the proteinoid or the hollowsphere.

The antifogging agent may be attached to the polymeric backbone either directly, or by means of a spacer. In some embodiments, the antifogging agent is characterized by a degree of polarity which is satisfactory to allow encapsulation thereof within the hydrophobic core of the proteinoid hollowsphere.

It is noteworthy that, for example, the proteinoids and the proteinoids-polyesters possess also many functional groups on the surface, e.g., amines, hydroxyls, carboxyls and thiols, which may be used for physical or covalent conjugation of biomolecules on the surface of these proteinoids.

Alternatively, the antifogging agent may be attached to a portion of the backbone units forming the polymeric backbone, directly or via a spacer. Alternatively, the antifogging agent may be encapsulated within the void space as described hereinabove.

In some embodiments, the antifogging agent is encapsulated within the proteinoids.

In some embodiments, a proteinoid has an average diameter size in the range of 100 nm to 400 nm, 105 nm to 400 nm, 110 nm to 400 nm, 130 nm to 400 nm, 150 nm to 400 nm, 200 nm to 400 nm, 250 nm to 400 nm, 100 nm to 395 nm, 100 nm to 390 nm, or 100 nm to 350 nm, including any range therebetween.

In some embodiments, a proteinoid with encapsulated antifogging agent has an average diameter size in the range of 400 nm to 700 nm, 410 nm to 700 nm, 420 nm to 700 nm, 430 nm to 700 nm, 440 nm to 700 nm, 450 nm to 700 nm, 500 nm to 700 nm, 400 nm to 690 nm, 400 nm to 680 nm, or 400 nm to 650 nm, including any range therebetween.

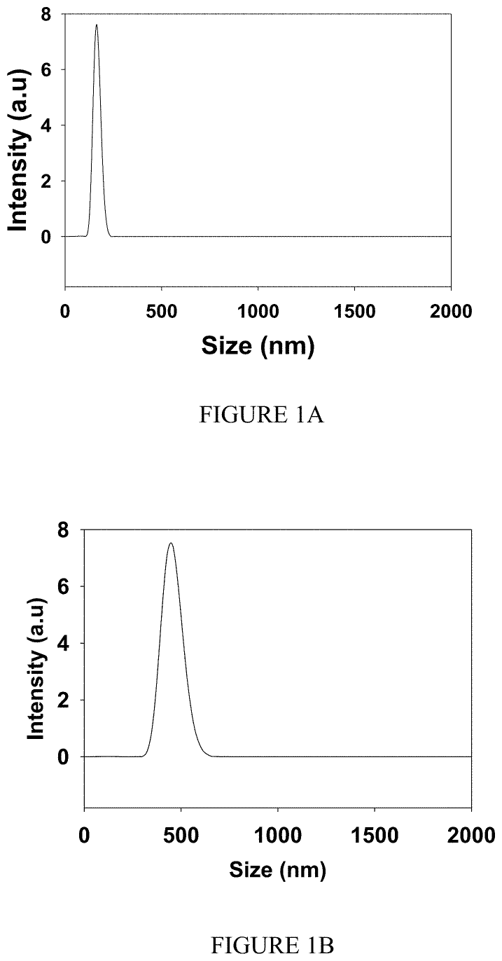

As further described in the Examples section that follows, the encapsulation may be approved by measuring the hydrodynamic size (also referred to hereinthroughout as “hydrodynamic diameter” or, for simplicity, “size” or “diameter”) of the proteinoids (see FIG. 1 and Table 2 hereinbelow).

Non-limiting examples of antifogging agents are selected from: sorbitan monooleate (SMO), glycerol monooleate (GMO), glyceryl monostearate, sorbitan monolaurate, sorbitan monostearate, sorbitan trioleate, sorbitan polyethylene oxide, sorbitan monopalmitate, polyoxyethylene sorbitan monolaurate, fatty acid ester of sucrose and any combination thereof.

In some embodiments the antifogging agent attached to, incorporated or encapsulated within the proteinoids are e.g., 1%, 5%, 10%, 15%, 20%, 25%, 30%, 35%, 40%, 45%, 50%, 55%, 60%, 65%, 70%, by weight, including any value therebetween.

As demonstrated in the Example section, proteinoids encapsulating antifogging agents may be characterized by a diameter of at least e.g., 20%, 30%, 40%, 50%, 60%, 70%, 80%, 90%, 100%, 150%, 200%, 250%, 300%, 350%, 400%, 500%, including any value therebetween, larger than the corresponding proteinoid not encapsulating antifogging agents.

As used herein “narrow hydrodynamic size distribution” is characterized by e.g., at least 60%, at least 70%, at least 80%, at least 90%, of the particles having a hydrodynamic size that varies within a range of less than 25% average hydrodynamic diameter.

In some embodiments, the “narrow hydrodynamic size distribution” is characterized by size distribution of at least 80% of the particles varying within a range of less than e.g., 60%, 50%, 40%, 30%, 20%, 10%, including any value therebetween.

In exemplary embodiments, the “narrow hydrodynamic size distribution” is characterized by size distribution of at least 80% of the particles varying within a range of less than e.g., 60%, 50%, 40%, 30%, 20%, 10%, including any value therebetween.

In some embodiments, the hydrodynamic size of the particles is affected by % (wt.) of the polyester in the polymeric backbone of the proteinoid. In some embodiments, the % (wt.) of the polyester has a value that ranges from 0% to about 15%. In some embodiments, the % (wt.) of the polyester has a value of 1%, 2%, 3%, 4%, 5%, 6%, 7%, 8%, 9%, 10%,11%, 12%, 13%, 14%, 15%, 16%, 17%, 18%, 19%, 20%, including any value therebetween.

As exemplified hereinthroughout, the polyester is poly-L-lactic acid.

As noted hereinabove, the amino acids may be racemic or of optical activity—L or D or mixed. Therefore, the proteinoids described herein may possess asymmetric carbon atoms (optical centers) or double bonds; the racemates, diastereomers, geometric isomers and individual isomers are further encompassed within the scope of the present invention.

As used herein, the term “enantiomer” describes a stereoisomer of a compound that is superposable with respect to its counterpart only by a complete inversion/reflection (minor image) of each other. Enantiomers are said to have “handedness” since they refer to each other like the right and left hand. Enantiomers have identical chemical and physical properties except when present in an environment which by itself has handedness, such as all living systems.

In some embodiments, the particles are characterized are characterized as being optically active. The term “optically active” means that the enantiomeric excess is greater than zero.

The Process

According to an aspect of some embodiments of the present invention there is provided a process of encapsulating anti-fogging agents within proteinoid particles.

As descried hereinthroughout the particles are micro sized or nano sized.

In some embodiments, the process comprises a step of mixing the proteinoids with one or more antifogging agents in an aqueous medium, thereby forming a dispension. In some embodiments, may comprise salt (e.g., NaCl).

In exemplary embodiments the antifogging agents are selected from SMO and GMO. The concentration of the salt may be e.g., 10⁻²N, 10⁻³N, 10⁻⁴N, 10⁻⁵N, 10⁻⁶N, including any value therebetween. In exemplary embodiments, the concentration of the salt is 10⁻⁵N.

In some embodiments, the step of mixing the proteinoids in aqueous medium, is performed while heating the aqueous medium to elevated temperature, e.g., 30° C., 35° C., 40° C., 45° C., 50° C., 55° C., 60° C., 65° C., 70° C., 75° C., 80° C., 85° C., 90° C., 95° C., or 99° C., including any value therebetween.

In some embodiments, the process comprises a step of cooling the medium to room temperature (e.g., about 25° C.), following the step of heating.

In some embodiments, the medium comprising the proteinoids and antifogging agents is stirred while cooling. Stirring may be performed at e.g., 50 rpm, 100 rpm, 150 rpm, 200 rpm, 300 rpm, 350 rpm, 400 rpm, 450 rpm, 500 rpm, including any value therebetween.

According to an aspect of some embodiments of the present invention there is provided a process of coating a substrate with proteinoids. As described hereinabove, the proteinoids may be in form of particles. In some embodiments, the proteinoids are characterized as having antifogging properties as described herein. As described hereinabove, the substrate may be in form of a film.

In some embodiments, prior to the coating process, the surface of the substrate is treated by methods known in the art, such as, and without being limited thereto, plasma treatment, UV-ozone treatment, or corona discharge. Various embodiments of the film and the primer are described hereinabove.

In some embodiments, the coating process comprises a step of heating the substrate prior to deposit of the proteinoids. In some embodiments, the coating process comprises a step of heating the proteinoids prior to deposit on the substrate. In some embodiments, the substrate is heated to a temperature that allows the softening of the substrate.

In some embodiments, the coating process comprises a step of adding a primer to an aqueous suspension or solution comprising proteinoid polymer, thereby forming a mixture. In some embodiments, the coating process comprises a step of adding a primer to an organic suspension or solution comprising proteinoid polymer, thereby forming a mixture. In some embodiments, the coating process comprises a step of adding a primer dissolved in an organic solvent to an aqueous or organic suspension or solution comprising proteinoid polymer, thereby forming a mixture.

In some embodiments, the coating process comprises a step of adding an organic solvent to proteinoid polymer, thereby forming a mixture. In some embodiments, an organic solvent is added to the proteinoid prior to deposit of the proteinoids. In some embodiments, an organic solvent is added to the substrate prior to deposit of the proteinoids. In some embodiments, an organic solvent softens the surface of a substrate.

In some embodiments, an organic solvent is a solvent that can be easily evaporated. In some embodiments, the organic solvent(s), suspension, or solution comprise, without being limited thereto, methyl ethyl ketone, toluene, butyl acetate, ethanol, isopropanol, or any mixture or combination thereof, e.g., a mixture of methyl ethyl ketone and toluene, a mixture of methyl ethyl ketone and butyl acetate, ethanol, isopropanol.

In some embodiments, the mixture comprises e.g., 1%, 2%, 3%, 4%, 5%, 6%, 7%, 8%, 9%, 10%, 11%, 12%, 13%, 14%, 15%,16%, 18%, 19%, 20%, 30%, 40%, or 50% (w/w proteinoid to primer), including any value therebetween.

In some embodiments, the coating process further comprises a step of spreading the mixture on the film.

In some embodiments, the coating process further comprises a step of evaporating the solvent(s) (e.g., the solvents dissolving the primer) from the primer or from the primer and proteinoid mixture or coating (e.g., the mixture or coating deposited on the film). The step of evaporating the solvent(s) may be performed at e.g., room temperature (i.e. 15° C. to 30° C.), or at elevated temperature, e.g., at 35° C., 40° C., 50° C., 55° C., 60° C., 65° C., 70° C., 75° C., 80° C., 85° C., or 90° C., including any value therebetween.

According to an aspect of some embodiments of the present invention, there is provided a process of incorporation of proteinoids in film by a process of extrusion. In some embodiments, the process entails extruding under extrusion coating conditions.

In some embodiments, the process comprises a step of mixing polymeric beads with a proteinoid particles. In some embodiments, the particles are in form of a powder. In some embodiments, the polymeric beads comprise a polymer selected from PP, PE, or any substrate discussed hereinthroughout.

Exemplary extrusion process and parameter relating thereof is described hereinbelow under the Example section.

In exemplary embodiments, the films obtained by the extrusion comprises PP and EI.

According to one aspect of some embodiments of the present invention, there is provided a method of reducing water contact angle on a surface of a substrate, the method comprising applying a composition as described elsewhere herein, to a surface.

According to one aspect of some embodiments of the present invention, there is provided a method of reducing water contact angle on a surface of a substrate, the method comprising applying a mixture of one or more proteinoid compounds, one or more corsslinkers and a photo initiator to a surface. In some embodiments, the method further comprises the step of UV curing the surface.

In some embodiments, the UV curing may be performed for 1 min, 30 min, 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h, 24 h, including any value and range therebetween.

In some embodiments, the process comprises a step of mixing a photo-initiator and a crosslinker in an organic solvent. In some embodiments, one or more proteinoid compounds are in an aqueous solution.

In some embodiments, the photo-initiator is selected from, without being limited thereto, 2,6-bis(4-azidobenzylidene)cyclohexanone; 2,6-bis(4-azidobenzylidene)-4-methylcyclohexanone; 4,4-diazidostilbene-2,2′-disulfonic acid disodium salt; ammonium dichromate; 1-hydroxy-cyclohexyl-pentyl-keton (Irgacure 907); 2-methyl-1[4-(methylthio)phenyl]-2-morpholinopropane-1-one (Irgacure 184C); 2-hydroxy-2-methyl-1-phenyl-propane-1-one (Darocur 1173); a mixed photo-initiator (Irgacure 500) of 50 wt % of Irgacure 184C and 50 wt % of benzophenone; a mixed initiator (Irgacure 1000) of 20 wt % of Irgacure 184C and 80 wt % of Darocur 1173; 2-hydroxy-1-[4-(2-hydroxyethoxy)phenyl]-2-methyl-1-propanone (Irgacure 2959); methylbenzoylformate (Darocur MBF); alpha, alpha-dimethoxy-alpha-phenylacetophenone (Irgacure 651); 2-benzyl-2-(dimethylamino)-1-[4-(4-morpholinyl)phenyl]-1-butanone (Irgacure 369); a mixed initiator (Irgacure 1300) of 30 wt % of Irgacure 369 and 70 wt % of Irgacure 651; diphenyl (2,4,6-trimethylbenzoyl)-phosphine oxide (Darocur TPO); a mixed initiator (Darocur 4265) of 50 wt % of Darocur TPO and 50 wt % of Darocur 1173; a phosphine oxide; phenyl bis(2,4,6-trimethyl benzoyl) (Irgacure 819); a mixed initiator (Irgacure 2005) of 5 wt % of Irgacure 819 and 95 wt % of Darocur 1173; a mixed initiator (Irgacure 2010) of 10 wt % of Irgacure 819 and 90 wt % of Darocur 1173; a mixed initiator (Irgacure 2020) of 20 wt % of Irgacure 819 and 80 wt % of Darcocur 1173; bis (etha 5-2,4-cyclopentadiene-1-yl) bis [2,6-difluoro-3 -(1H-pyrrole-1-yl)phenyl]titanium (Irgacure 784); a mixed initiator containing benzophenone(HSP 188); and derivatives thereof.

As used herein, “crosslinked” and/or “crosslinking”, and any grammatical derivative to thereof refers to a chemical process or the corresponding product thereof in which two chains of polymeric molecules are attached by bridges (crosslinker) composed of an element, a group or a compound, which join certain carbon atoms of the chains by primary chemical.

The term “crosslinker” as used herein, refers to any molecule that is hydrophilic and has a plurality of polymerizable groups. In some embodiments, the cross-linker is a degradable (e.g. biodegradable) cross-linker, including those containing disulfide bonds, ester bonds, carbonate bonds, amide bonds, or other bonds in the crosslinker backbone that may be cleaved.

The term “UV curing” as used herein refers to a process in which ultraviolet light and visible light are used to initiate a photochemical reaction that generates a crosslinked network of polymers.

In some embodiments, the crosslinker is selected from, without being limited thereto, polyethylene glycol (PEG), polyethyleneglycol diacrylate (PEGDA), ethylene glycol dimethacrylate (EGDMA); methacryloyloxy ethyl-N-(2-methacryloyloxy ethyl phosphorylcholine); di-, tri-, tetra-, penta-, and hexa(ethylene glycol) dimethacrylate; “Medium” length PEG crosslinkers, such as PEG diacrylates or PEG dimethacrylates with molecular weights ranging from 500 Da to 50,000 Da (e.g., 500, 1,000, 2,000, 3,400, 5,000, 10,000, 20,000, and 50,000 Da). In some embodiments, the cross-linker is methylene bisacrylate, methylene bisacrylamide, methylene bismethacrylate, or methylene bismethacrylamide. In some embodiments, the crosslinker is polyethyleneglycol diacrylate (PEGDA).

General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

### EXAMPLES

### Example 1

### Synthesis Methods

Preparation of Proteinoids by Thermal Condensation Polymerization

In exemplary procedures, (L)glutamic acid (2.5 g) was heated to the molten state (180° C.) in an oil bath, under nitrogen atmosphere. The molten mass was stirred at 180° C. for 30 min. To this, an equivalent amount of either (L)phenylalanine, (L)isoleucine or a mixture of both amino acids was added to give a total monomer weight of 5 g and kept at 180° C. under N2. The mixture was mechanically stirred at 150 rpm for 1 h. The product is a highly viscous orange-brown paste, which hardens to give a glassy mass when cooled to room temperature. Then, water (10 mL) was added to the crude product, and the mixture was stirred for 20 min.

The solution was then intensively dialyzed through a cellulose membrane (3500 Da MWCO) against distilled water. The content of the dialysis tube was then lyophilized to obtain a yellow-white proteinoid powder.

The molecular weights and polydispersity index of the dried crude proteinoids were determined using Gel Permeation Chromatography (GPC).

Preparation of Proteinoid Nano/Micro-Particles by a Self-Assembly Process

In exemplary procedures, proteinoid particles were prepared by a self-assembly mechanism. Briefly, 100 mg of the dried proteinoid were added to 10 mL double-distilled water. The mixture was then heated to 80° C. until the crude proteinoid dissolves completely. Proteinoid particles were then formed by removal of the heating and leaving the mixture to cool to room temperature. The obtained particles were dialyzed through a cellulose membrane (1000 Da MWCO) against distilled water to wash off excess reagents.

Characterization of the Proteinoid Nano/Micro-Particles

In exemplary procedures, hydrodynamic diameter and size distribution of the particles dispersed in double distilled (DD) water were measured at room temperature with a particle DLS analyzer model Nanophox (SympatecGmbH, Germany).

In exemplary procedures, dried particle size and size distribution were measured with a Scanning Electron Microscope (SEM). SEM pictures were obtained with a JEOL, JSM-840 Model, Japan. For this purpose, a drop of dilute particle dispersion in distilled water was spread on a glass surface, and then dried at room temperature. The dried sample was coated with carbon in vacuum before viewing under SEM. The average particle size and distribution were determined by the measurement of the diameter of more than 200 particles with image analysis software (Analysis Auto, Soft Imaging System GmbH, Germany).

Encapsulation of anti-fogging agents within the proteinoid nano/micro-particles In exemplary procedures, to the heated proteinoid mixture (10 mg in 9.8 mL NaCl 10-5N, at 80° C.), different percentages of sorbitan monooleate and/or glycerol monooleate (SMO and GMO, respectively) were added. The heating was stopped, the mixture was mechanically stirred at 250 rpm and left to cool to room temperature in order to form the proteinoid particles containing the encapsulated material.

The particles were washed and characterized as mentioned before for their size and size distribution. The particle stability was tested for the filled particles, as mentioned before, in dispersion at 4° C. The particles dispersions were checked both for soluble proteinoid in the aqueous phase and by organic-aqueous phase separation. Also, the particles dispersions were checked by Nanophox for their size and size distribution.

Coating of Plastic Films by Anti-Fogging Proteinoids Polymers and Particles Free or Containing Anti-Fogging Agents

In exemplary procedures, oxygen plasma-treated (or air corona-treated) polypropylene, polyethylene and polyethylene terephthalate (PP-t, PE and PET, respectively) films were coated in two steps. First, a mixture of A131-X (polyethyleneimine solution in water, MICA, USA) typical primer with either proteinoid particles aqueous dispersion or the crude proteinoid polymer was made (5% w/w proteinoid to primer). Then, the mixture was spread on PP-t and PET films using Mayer rod or by spray. After the coating process, the films were left to dry overnight. A131-X is a typical adhesive solution composed of an aqueous solution of polyethyleneimine allowing good adhesion of the proteinoids and particles to the film surface. The pre-treatment by oxygen plasma improves the wetting and the coating of the PP.

Similar exemplary procedures were carried out substituting the polyethylenimine primer for other adhesives such as Methocel E3 (methyl cellulose) or polyvinyl alcohol/acetate (PVA 8-88 or PVA 4-88) aqueous solutions, etc.

The coating process of the substrate is often done by two steps: first coating of the polymer former (e.g., pressure adhesive), followed by the proteinoid polymer or particles. The coating process may be done by a Mayer rod or spraying.

Preparation of Proteinoid-Plastic Films by Extrusion

In exemplary procedures, PP-P(EI) and PE-P(EI) films were made by extrusion at 1 and 2% w/w proteinoid to plastic PP or PE beads. First, a mixture of PP or PE beads was mixed with proteinoid powder to make compound proteionoid-plastic beads, using Prism Eurolab 16xL (Thermo) with a 16 nm double-screw extruder, with length L020, at 250 rpm and 65-70 torr. The extrusion temperature was 210-220° C. and 180-190° C. for PP and PE, respectively. The extruded fibers were ground into beads, which then were heat-compressed into 200 μm films at the same temperatures mentioned before.

### Example 2

### Characterization

Haze measurements were performed using Haze-Gard Plus 4752 model (BYK-Gardner) using ASTM D1003 standard. Gloss measurements were performed using Micro-Gloss 45° 4535 model (BYK-Gardner) using ASTM D2457 standard. Atomic force microscopy (AFM, NanoScope 9) images were recorded in air on unmodified and modified films, operated in tapping mode. 3 μm×3 μm scans were recorded in tapping mode in frequency of 300-600 kHz using FastScan 1-3 N/m probe (Bruker). All the AFM images were obtained in air at room temperature. The roughness measurements were obtained in root mean square (Rq) values. The reported values are an average of at least 3 different points of four different films. The sessile drop measurements (water contact angle) were done using a Goniometer, System OCA, model OCA20. 5 μL of distilled water was dropped on five different areas of each film. All of the measurements were done at 25° C. and 60% moisture. Each result represents an average of 4 measurements with up to 5% standard deviation. Untreated PP and PP-t were used as a reference.

### Hot Fog Test

Briefly, 5 mL of water were put in a 20 mL glass vial and covered by the different non-coated and coated films. The vials were then heated at 60° C. for 3 h.

### Cold Fog Test

Briefly, 5 mL of water were put in a 20 mL glass vial and covered by the different non-coated and coated films. The vials were refrigerated at 4° C. for 3 days.

### Example 3

### Results

The molecular weights and weights distribution (PDI) of poly(L-glutamic acid-L-phenylalanine), poly(L-glutamic acid-L-Isoleucine) and poly(L-glutamic acid-L-phenylalanine-L-Isoleucine) (P(EF), P(EI) and P(EFI), respectively) are shown in Table 1.

TABLE 1
Mw, Mn, Mp and PDI of the proteinoids.

| Proteinoid | Mw(Da) | Mn(Da) | Mp(Da) | PDI |
|---|---|---|---|---|
| P(EF) | 68380 | 65720 | 54980 | 1.04 |
| P(EI) | 57170 | 53220 | 42210 | 1.04 |
| P(EFI) | 60920 | 56780 | 43680 | 1.07 |
| P(KHW) | 10030 | 9000 | | 1.1 |

Molecular masses were measured by GPC, Mp is the molecular mass at the peak; PDI is the polydispersity index, given by Mw/Mn.

### Particle Size and Size Distribution

FIG. 1 shows the hydrodynamic diameters of P(EI) and P(EI) containing 10% SMO, measured by DLS.

Table 2 below shows the hydrodynamic particles size of P(EI) and P(EF) and the respective SMO-containing particles.

TABLE 2

| Sample | Particle size (nm) |
|---|---|
| P(EI) | 172 ± 20 |
| P(EI)-10% SMO | 442 ± 59 |
| P(EF) | 130 ± 42 |
| P(EF)-10% SMO | 591 ± 139 |
| P(EFI) | 331 ± 12 |
| P(EF)-10% SMO | 550 ± 64 |

As abovementioned, the hydrodynamic diameter raises when SMO is encapsulated within the proteinoid particles (442±59, 591±139 and 550±64 nm for P(EI), P(EF) and P(EFI), respectively), in comparison to the empty particles (172±20, 130±42 and 331±12 nm for P(EI), P(EF) and P(EFI), respectively). This may indicates that SMO molecules were encapsulated within the proteinoids.

### Coated Films Characterization

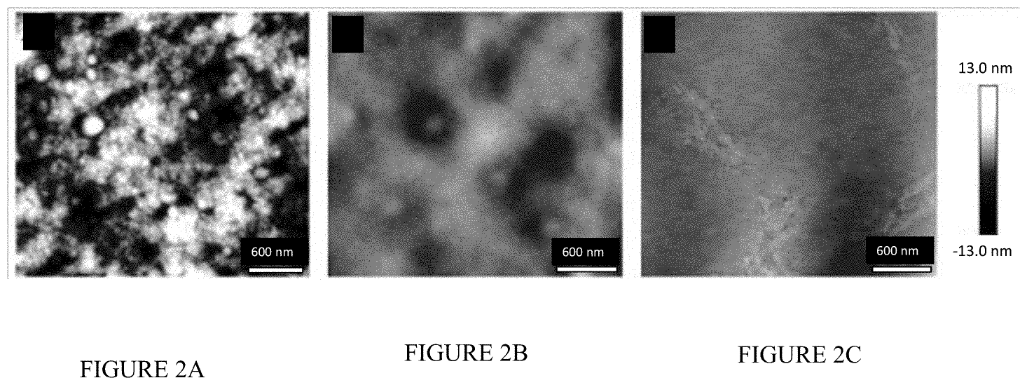

The coated films surface topography by AFM is shown in FIGS. 2A-C which present images of PP-t (FIG. 2A), PP film coated with P(EF) (FIG. 2B) and PP film coated with P(EI) (FIG. 2C). Table 3 below shows the characterization of the coated films, e.g. surface roughness, contact angle, haze and gloss.

TABLE 3

| | | Contact | | |
|---|---|---|---|---|
| | Roughness | angle | Haze | Gloss |
| Sample^{a} | (nm)^{c} | (°)^{c} | (%)^{c} | (%)^{c} |
| PP-t^{b} | 4.7 ± 0.2 | 29 ± 1 | 2.70 ± 0.10 | 82.0 ± 1.6 |
| PP-t A131-X | 3.8 ± 0.9 | 70 ± 2 | 2.36 ± 0.13 | 80.9 ± 7.2 |
| PP-t A131-X P(EI) | 0.7 ± 0.1 | 7 ± 0.7 | 2.29 ± 0.17 | 88.5 ± 1.4 |
| PP-t A131-X P(EI) | 0.8 ± 0.3 | 9 ± 1 | 2.00 ± 0.11 | 84.3 ± 2.0 |
| particles | | | | |
| PP-t A131-X P(EI) | 1.2 ± 0.3 | 30 ± 0.5 | 2.16 ± 0.02 | 86.6 ± 1.6 |
| particles with | | | | |
| 10% SMO | | | | |
| PP-t A131-X P(EFI) | 1.1 ± 0.5 | 6.5 ± 0.7 | 2.30 ± 0.15 | 88.4 ± 2.6 |
| PP-t A131-X P(EFI) | 1.4 ± 0.6 | 43 ± 2 | 2.22 ± 0.11 | 91.0 ± 1.2 |
| particles | | | | |
| PP-t A131-X P(EFI) | 1.3 ± 0.6 | 44.5 ± 1 | 2.53 ± 0.14 | 85.8 ± 1.2 |
| particles with | | | | |
| 10% SMO | | | | |
| PP-t A131-X P(EF) | 1.2 ± 0.6 | 9 ± 1 | 2.54 ± 0.18 | 90.9 ± 0.8 |
| PP-t A131-X P(EF) | 1.5 ± 0.6 | 20.5 ± 1 | 2.38 ± 0.14 | 86.6 ± 1.6 |
| particles | | | | |
| PP-t A131-X P(EF) | 1.5 ± 0.7 | 24 ± 1.5 | 2.31 ± 0.26 | 84.1 ± 8.6 |
| particles with | | | | |
| 10% SMO | | | | |

In Table 3:
^{a}All samples refer to PP-t films coated with primer (A-131-X), proteinoid or proteinoid particles as specified, at 5% w/w polymer or polymer particles to primer;
^{b}PP-t is plasma-treated uncoated polypropylene film;
^{c}each result represents an average of three measurements at three different areas of the films.

### Hot Fog Test

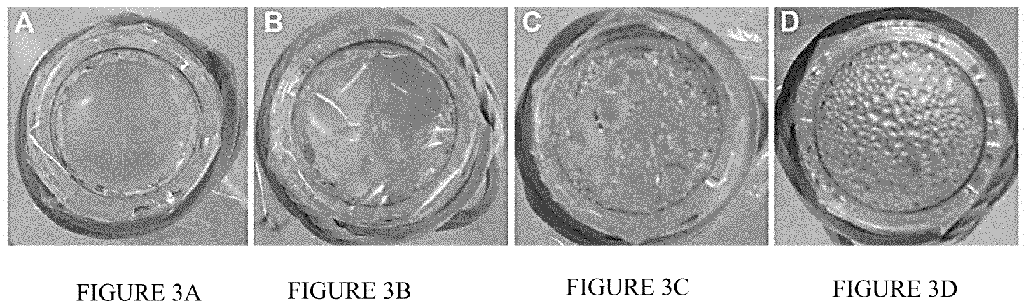

The coated films were tested as mentioned before. Table 4 shows the results over 3 h and FIGS. 3 shows the range of optical visibility through the films, ranked as A-D.

TABLE 4

| | Test time (min) | | |
|---|---|---|---|
| Sample | 5 | 60 | 180 |
| PP | D | D | D |
| PP-t^{a} | D | D | D |
| PP-t A131-X | D | D | D |
| PP-t A131-X P(EI) | A | A | A |
| PP-t A131-X P(EI) | B | A | A |
| particles | | | |
| PP-t A131-X P(EI) | D | B | A |
| particles containing | | | |
| 10% SMO | | | |
| PP-t A131-X P(EFI) | D | B | A |
| PP-t A131-X P(EFI) | D | B | A |
| particles | | | |
| PP-t A131-X P(EFI) | D | B | A |
| particles containing | | | |
| 10% SMO | | | |
| PP-t A131-X P(EF) | D | A | A |
| PP-t A131-X P(EF) | D | B | A |
| particles | | | |
| PP-t A131-X P(EF) | D | B | A |
| particles containing | | | |
| 10% SMO | | | |

In Table 4 ^{a} refers to oxygen plasma treated polypropylene film.

As shown in Table 4, PP and PP-t films with no coating show poor visibility, ranked as D over 3 h, with no change. Coating the films with A131-X does not improve the visibility during the hot fog test. However, when coated by P(EI) in A131-X, it can be seen that the visibility improves to rank A within 5 min and stays the same over 3 h. Coating with P(EF) or P(EFI) show rank A after 60 min. An improvement can also be seen when coating with P(EI) and P(EF) particles and particles with SMO, but over more time (5-60 min to rank B and 3 h to to rank A).

### Cold Fog Test

The coated films were tested as mentioned before. Table 5 shows the results over 3 h ranked as A-D, as described before.

TABLE 5

| | Test time (min) | | |
|---|---|---|---|
| Sample | 5 | 60 | 180 |
| PP | D | D | D |
| PP-t^{a} | D | D | D |
| PP-t A131-X | D | D | D |
| PP-t A131-X P(EI) | B | A | A |
| PP-t A131-X P(EI) | C | A | A |
| particles | | | |
| PP-t A131-X P(EI) | D | D | D |
| particles with | | | |
| 10% SMO | | | |
| PP-t A131-X P(EFI) | D | C | B |
| PP-t A131-X P(EFI) | D | C | B |
| particles | | | |
| PP-t A131-X P(EFI) | D | C | B |
| particles with | | | |
| 10% SMO | | | |
| PP-t A131-X P(EF) | D | D | D |
| PP-t A131-X P(EF) | D | D | B |
| particles | | | |
| PP-t A131-X P(EF) | D | D | D |
| particles with | | | |
| 10% SMO | | | |

In Table 4 ^{a} refers to oxygen plasma treated polypropylene film.

In Table 4^{a} refers to oxygen plasma treated polypropylene film.

The results shown the table 5 refer to the first 3 h of the test as the results stay the same for the rest of the test, e.g. up to 3 days. As shown, cold fog is present all the time, at rank D for PP, PP-t and PP-t with A131-X. An improvement is shown when coating with P(EI) after 5 min to rank B and after 1 h to rank A. The P(EI) particle coating shows less improvement over 5 min, to rank C, but over 1 h rank A is achieved. However, the P(EI) with encapsulated SMO does not show any improvement over time and the films stay at rank D for 3 days. P(EFI) proteinoid, particles and SMO-containing particles coatings show a little improvement over 1 h to rank C and over 3 h to rank B, and stays at rank B for the rest of the test. P(EF) in all the forms shows rank D at all timed of the test, excluding the particles which improve to rank B at 180 min.

It should be noted that the films containing the proteinoids denoted as “A” kept their antifogging properties for at least several months. Migration of the proteinoids, thereby losing the antifogging properties, is avoided by improving the interaction of the proteinoids with the primer and/or the films type.

### Example 4

### Synthesis Methods

### Preparation of Proteinoids by Thermal Step Growth Polymerization Materials

The following analytical-grade chemicals were purchased from commercial sources and were used without further purification: (L) glutamic acid (Glu, E), (L) phenylalanine (Phe, F), (L) isoleucine (Ile, I), (L) lysine (Lys, K), tetraethylene glycol diacrylate (TEGDA) and polyethylene glycol diacrylate 400 Da (PEGDA 400) from Sigma (Rehovot, Israel); photo-initator 819-DW (IRGACUR Ciba), PET films (air corona-treated) of A4 size and 36 μm average thickness from Hanita Coatings Ltd., Israel. Water was purified by passing deionized water through Elgastat Spectrum reverse osmosis system (Elga Ltd., High Wycombe, UK).

Preparation and Characterization of Proteinoids by Thermal Step-Growth Polymerization

A selection of amino acids was used to prepare a series of proteinoids: (L) glutamic acid (Glu, E), (L) phenylalanine (Phe, F), (L) lysine (Lys, K), (L) serine (ser, S) and (L) isoleucine (Ile, I) in different weight ratios, to give a total monomer weight of 5 g, as specified in Table 6. Each mixture of amino acids was heated in a heating mantle to 180° C., under nitrogen. The mixture was kept at 180° C. and mechanically stirred at 150 rpm for 45 min, to yield a brown glassy mass. When the mixture cooled to room temperature, water (15 mL) was added to the crude product, and the mixture was stirred overnight. The solution was then intensively dialyzed through a cellulose membrane (500-1000 Da MWCO) against distilled water. The content of the dialysis tube was then lyophilized to obtain a yellow-white proteinoid powder.

TABLE 6

Amino acid content (g) ^{a}

| Proteinoid | Glu | Lys | Ile | Phe |
|---|---|---|---|---|
| P(KI) | — | 2.5 | 2.5 | — |
| P(KF) | — | 2.5 | — | 2.5 |
| P(EI) | 2.5 | — | 2.5 | — |

^{a} Total monomer weight is 5 g. All amino acids used were of the L-form.

The molecular weights and polydispersity indices of the proteinoids were determined using Gel Permeation Chromatography (GPC) consisting of a Waters Spectra Series P100 isocratic HPLC pump with an ERMA ERC-7510 refractive index detector and a Rheodyne (Coatati, Calif.) injection valve with a 20 μL loop (Waters, Mass.). The samples were eluted with super-pure HPLC water through a linear BioSep SEC-s-3000 column (Phenomenex) at a flow rate of 1 mL/min. The molecular weight was determined relative to poly(ethylene glycol) standards (Polymer Standards Service-USA, Silver Spring, Md., USA) with a molecular weight range of 100-450,000 Da, human serum albumin (67 kDa, Sigma Aldrich) and bovine plasma fibrinogen (340 kDa, Sigma Aldrich), using Clarity chromatography software.

Preparation of Proteinoids Containing Activated Double Bonds by Michael Addition Reaction

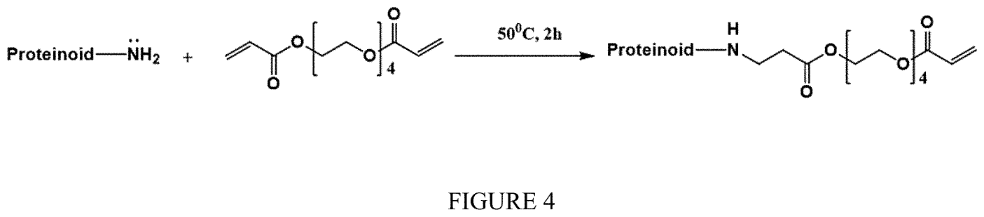

The proteinoids, which were mentioned before, were used as is after the proteinoid preparation. Michael reaction was done to create double bonds in the proteinoid by interacting free amino groups of the proteinoid with double bonds belonging to excess of a crosslinker vinylic oligomer PEGDA 400, which would allow stronger adhesion by UV curing. Briefly, the crude proteinoids were dissolved in water (100 mg in 1 mL) and the pH was changed to 8-9 in the acidic proteinoid (P(EI)) by NaOH 1M (400 4). TEGDA (10 mg) was added to the proteinoid aqueous solution, and then the mixture was heated to 50° C. and stirred for 120 min, to yield the proteinoid prepolymer containing activated double bonds. A scheme of the process is shown in FIG. 4.

Preparation of the Anti-Fog Coatings

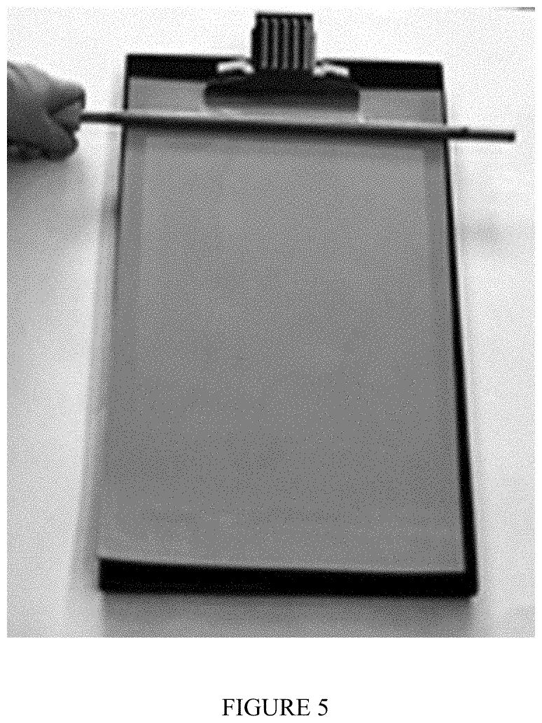

PET films were coated by a UV curing method with the anti-fog mixture. PET was pre-treated by corona with iCorona-1 (VETAPHONE Corona & Plasma, Denmark) at 300 W. min/m², to improve the adhesion of the coating on the plastic films. Then, mixtures of film formers were prepared, as follows: PEGDA 400 in varying amount: 5% 10% 15% and 20% w/v in ethanol was mixed with 1 mg/mL photo-initiator 819-DW (IRGACUR Ciba,), named A1, A2, A3 and A4, respectively. The photo-initiator 819-DW is a water dispersion of bisacylphosphine oxide (BAPO). After that, the proteinoid prepolymer aqueous solutions (100 mg in 1 mL water) were added to the 1 mL of the film former solution. In the next step, the different mixtures of film former and proteinoid (Table 7) were spread on PET film by Mayer rod with thickness of 6μ. The system of the coating with the Mayer rod were displayed in FIG. 5. Following this coating process, the coating was dried in a heating oven at 80° C. for a few minutes. Then, the coatings was cured by UV Testing model RW-UVA201-20 with power supply of 220VAC 50HZ and at speed of 35 m/min, under UV lamp type high-pressure mercury lamp with power of 100 w/cm and main wavelength of 365 nm, to achieve a dried coated film.

### Example 5

### Characterization of the Anti-Fog Coatings

Fourier transform infrared measurements (FTIR) were performed by the attenuated total reflectance (ATR) technique, using a Bruker ALPHA Fourier transform infrared QuickSnapTM sampling module equipped. FTIR measurements were done on PET uncoated and coated with film former A4 before and after UV curing, In order to evidence that all the monomers (PEGDA) have reacted completely during the photo-polymerization process.

Surface topography analysis of the coated and uncoated PET were obtained using atomic force microscopy (AFM, NanoScope9, Bio FastScan, Bruker AXS, Santa Barbara, Calif.). All images were obtained using soft tapping mode with a FastScan-B (Bruker) silicon probe. The images were captured in the retrace direction with a scan rate of 1.4 Hz. Scans for each film were performed on an area of 3 μm×3 μm. The height images were captured with 512 scans/line image resolution. AFM images were obtained in air at room temperature. Before analysis of the images, the second order “flatting” and first “planefit” functions were applied to each image. The analysis of the height images was done by using the NanoScope Analysis Software. The morphological changes of the films were determined by the root mean square roughness (Rq) values averaged over three different regions on each film. The reported values are an average of at least 3 different points of four different films.

The sessile drop measurements (water contact angle) were done using a Goniometer, (System OCA, model OCA20, Data Physics Instruments GmbH, Filderstadt, Germany). Drops of 5 μL distilled water were dropped on five different areas of each film and images were captured a few seconds after the deposition. The static water contact angle values were performed using LaplaceYoung curve fitting. All of the measurements were done at 25° C. and 60% moisture. Each result represents an average of 4 measurements with up to 5% standard deviation. Uncoated PET was used as a reference.

Haze measurements and transmission were performed using Haze-Gard Plus 4752 model with ASTM D1003 standard (BYK-Gardner, Germany). Haze-gard plus instrument was used to evaluate the degrading visibility of different damage modes by measuring the haze level increase. In the measurement, the transparent specimen is illuminated at normal incidence, and the transmitted light is measured photo-electrically by an integrating sphere. Haze is caused by wide-angle scattering. According to ASTM D1003, haze is the percentage of transmitted light that deviates from the incident beam by more than 2.58 on the average. When the total transmittance is measured, the sphere's normal outlet is closed, and when haze is measured, the normal outlet is opened. Increase of haze of a transparent sample reduces the contrast of an object viewed through the transparent sample and results in a milky or cloudy appearance of the object.

Gloss measurements were performed using Tri-Gloss Master 20-60-85°, model Multi-angle Glossmeter (SH260C), (Sheen instruments, USA).

The anti-fog behavior of the films was studied using a hot fog test and a cold fog test, conducted as follows. An open 28 mL vial filled with 10 mL water was covered with a 5 cm×5 cm film, subsequently kept in a 60° C. water bath or at 4° C. in a refrigerator for 180 min. Variations of the optical visibility of the films were observed and recorded at different time intervals. Ratings of A to D were used, where D denotes zero visibility with an opaque layer of small water droplets and A describes excellent optical visibility where a transparent continuous film of water is displayed (FIG. 3A-D).

### Example 6

### Results

### Synthesis and Characterization of the Proteinoids

Proteinoids were prepared by thermal step-growth polymerization of different amino acids and characterized for their molecular weights and polydispersity, as shown in Table 2. The synthesized proteinoids were of relatively high molecular weights, in the range of 35-95 kDa with narrow polydispersity index (PDI) in the range of 1.00-1.05. This indicates that the simple thermal polymerization procedure used here provides relatively long polymer chains with a very narrow PDI, as already reported in previous studies of our group. Furthermore, Table 7 shows that all proteinoids exhibit optical activity, although the monomers are known to racemize during the thermal process.

TABLE 7

| | | | | | Optical |
|---|---|---|---|---|---|
| | | | | | Activity |
| | | | | | [α]_{D}^{25° C.} |
| Proteinoid^{a} | Mn (kDa)^{b} | Mw (kDa)^{b} | Mp (kDa)^{b} | PDI^{c} | (°)^{d} |
| P(KI) | 36 | 35 | 36 | 1.00 | −59 |
| P(KF) | 87 | 95 | 100 | 1.05 | −5 |
| P(EI) | 66 | 68 | 55 | 1.04 | −1.7 |

^{a}The proteinoids were prepared at 180° C. according to the experimental section;
^{b}molecular weights were measured by GPC, Mp is the molecular weight at the peak;
^{c}PDI is the polydispersity index, given by Mw/Mn;
^{d}specific optical rotation (c = 1, in H₂O, at 25° C.), each experiment was performed 4 times, with an error of 0.5-2%.

Film Former Coated PET Film Characterization

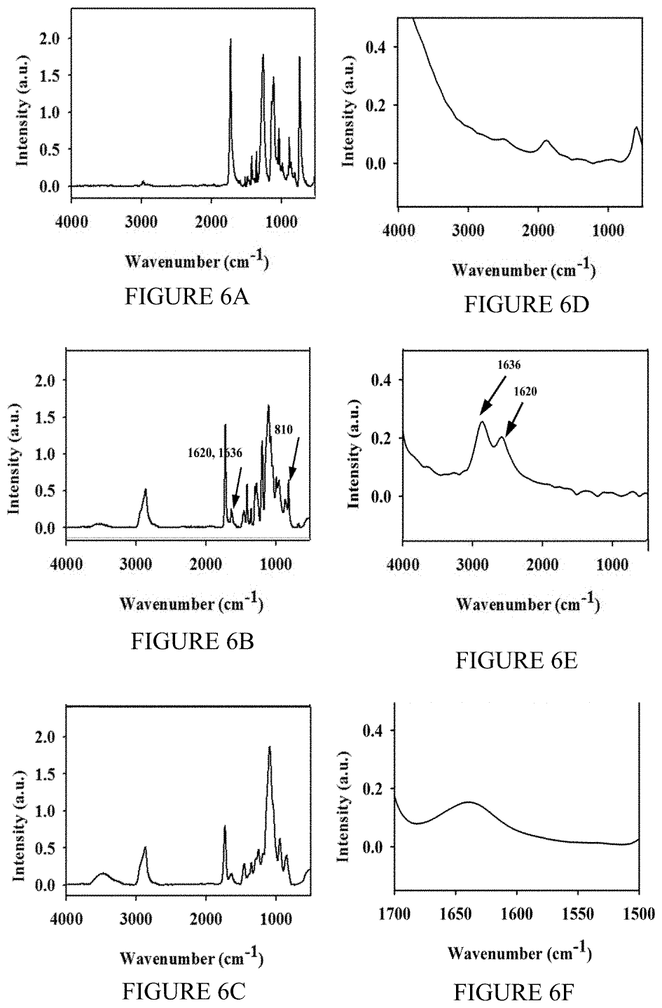

The FT-IR spectra of PET, PET/PEGDA before and after UV curing are shown in FIGS. 6A-F.

FIGS. 6A and D exhibits the spectrum of PET film with main absorption bands at 1712 cm⁻¹ (C═O stretching), 1409 cm⁻¹ (ring CH in-plane bending, ring CC stretching), 1338 cm⁻¹ (CH₂, O—C—H bending), 1099 cm⁻¹ (C—O stretching), 1017 cm⁻¹ (ring CCC bending, ring CC stretching, ring CH in-plane bending), 870 cm⁻¹ (ring CH out-of-plane bending, ring ester CC out-of-plane bending, C═O out-of-plane bending, ring torsion), 722 cm⁻¹ (C═O out-of-plane bending, ring torsion, ring CH out-of-plane bending).

FIGS. 6B and E and FIGS. 6C and F exhibit the spectrum of PET after coatings with PEGDA 400 before and after UV curing, respectively. FIG. 6B, before UV curing, exhibits main absorption bands at 1620, 1636-1647 cm¹ and 810 cm⁻¹ (C═C stretching arising from the presence of terminal acrylate group). These peaks were not observed after UV curing as shown in FIG. 6C, which is an evidence that all the double bonds of the PEGDA monomer have reacted during the polymerization process. Other prominent peaks were observed at 1731 cm¹ (C═O stretching), 2885-2287 cm¹ (CH stretching), 1351-1352 cm⁻¹ (CO asymmetric bending), 1243-1283 cm¹ (CO asymmetric bending), 1107-1194 cm⁻¹ (COC symmetric stretching,).

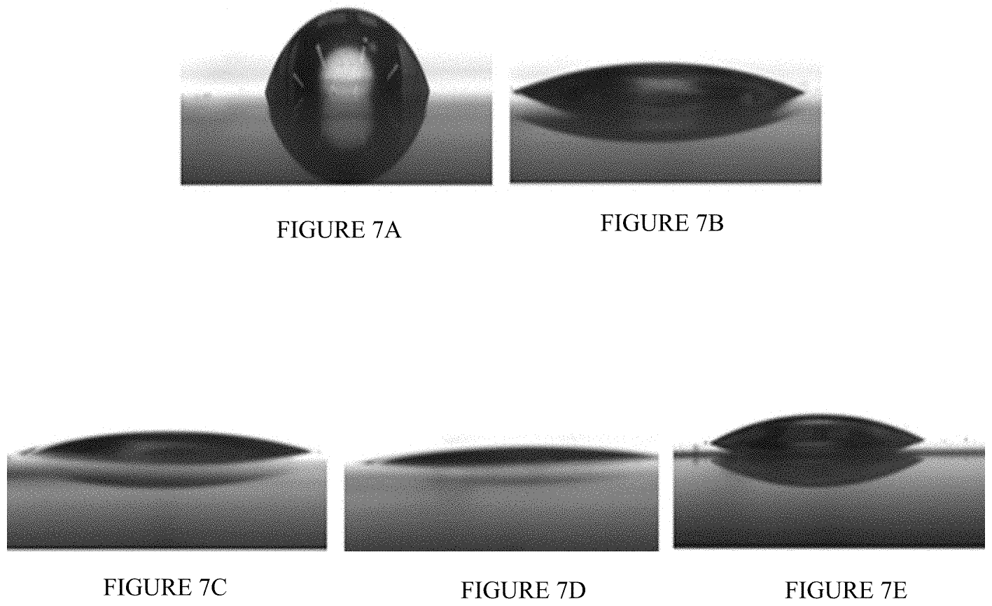

PET films were coated by the different film former solutions containing photo initiator and different concentrations of PEGDA (5,10, 15 and 20%, named A1, A2, A3 and A4, respectively) and by the mixture of film formers and the proteinoid prepolymers, as described in the experimental part. Table 8 and FIG. 7 illustrate the measured surface roughness and water contact angles of the uncoated and coated films. For the roughness measurements, it is clearly shown that coating by film former improves the smoothness of the film. PET films that were treated by air corona, showed roughness of 3.61 nm. The high roughness of the uncoated corona-treated PET film is caused due to the collisions of oxygen and nitrogen ions with the film, creating pores in the surface. Coating the PET films with the film former itself, improves the roughness, as shown in Table 9, for film formers A1-A4 ranging from 2.31 to 0.37 nm, respectively. PET films coated with the proteinoid prepolymers-film former mixtures display different surface roughness, depending on the type of proteinoid used. Coatings using P(KI) or P(EI) yields a high surface roughness, mostly above the roughness of uncoated PET films. It is possible that the increase in surface roughness is as a result of non-uniform spreading of the coatings on the PET films. However, PET films after coating with P(KF) display roughness in the range of 0.22-1.09 nm. The surface roughness significantly decreases and the film becomes smoother compared to the uncoated PET and coatings with the other proteinoids. This may be explained by the significance of incorporating phenylalanine in the proteinoid backbone, which improves the hydrophobic interaction between the P(KF) and the PET film surface. The similarity in the chemical structure between the phenylalanine group and the PET films form better compatibility than in isoleucine side chain, as in P(EI) and P(KI). Isoleucine includes a side chain that complicates the good interaction and the compatibility between either P(EI) or P(KI) and the PET film.

When investigating the water contact angle of all film surfaces, as shown in Table 8, it can be clearly seen that all the coatings led to a decrease of the contact angle, compared to the uncoated PET films. This decrease yields a range of required values for anti-fogging properties. The low contact angle degrees indicate the hydrophilicity of the coated films, hence achieving a good wetting character of the surface. Air corona-treated PET films possess a water contact angle of 69°. Coatings with film former only, reduced the contact angle to 28.3-33.6°, while coating with the film former-proteinoid prepolymers mixtures reduced the contact angle further to very low values, up to 5.1°. As mentioned above, in order to achieve a good anti-fog coating, reaching a low contact angle value is important. Surfaces which exhibit water contact angles of less than 40° are often defined as anti-fog coatings⁴. The lowest water contact angles were achieved by the mixtures P(KI) and (P(EI) with the film former.

FIG. 7A-E illustrates the visual difference in the contact angle between uncoated and film former-proteinoid prepolymer coated PET films. As seen, the water spread into a continuous and uniform layer only on the film former-proteinoid coated film (C, D and E) with contact angle in range of 8.5-20.7°. Nevertheless, on uncoated PET films the water form ball-shaped droplets on the surface (A) with contact angle of 69.3°. The coating changes the interfacial tension between the water and the PET surface and enables strong connectivity between the film and the water droplets.

TABLE 8

| Coating type^{a} | Roughness (nm)^{b} | Contact angle (°)^{b} |
|---|---|---|
| Uncoated PET | 3.61 ± 0.08 | 69.3 ± 1.0 |
| A1 | 2.31 ± 0.27 | 33.6 ± 1.0 |
| A2 | 1.00 ± 0.52 | 32.3 ± 1.2 |
| A3 | 0.96 ± 0.36 | 28.5 ± 0.5 |
| A4 | 0.37 ± 0.14 | 28.3 ± 1.4 |
| P(KI)A1 | 9.06 ± 2.73 | 5.1 ± 0.5 |
| P(KI)A2 | 7.37 ± 2.75 | 8.5 ± 0.7 |
| P(KI)A3 | 3.68 ± 0.61 | 7.3 ± 2.7 |
| P(KI)A4 | 15.8 ± 9.44 | 8.0 ± 1.6 |
| P(KF)A1 | 0.22 ± 0.02 | 22.7 ± 0.4 |
| P(KF)A2 | 0.27 ± 0.02 | 20.7 ± 0.4 |
| P(KF)A3 | 0.31 ± 0.61 | 20.8 ± 1.0 |
| P(KF)A4 | 1.09 ± 0.63 | 25.4 ± 2.2 |
| P(EI)A1 | 4.19 ± 1.42 | 10.9 ± 2.6 |
| P(EI)A2 | 2.42 ± 0.43 | 10.5 ± 0.1 |
| P(EI)A3 | 6.42 ± 2.19 | 7.1 ± 1.5 |
| P(EI)A4 | 10.2 ± 5.1 | 5.6 ± 1.4 |

^{a}All samples refer to corona-treated PET films (30 μm) coated with film former (A1, A2, A3 and A4 containing 5, 10, 15 and 20% PEGDA 400, respectively) or a proteinoid-film former as describe in the experimental part;
^{b}each result represents an average of three measurements at three different areas of the film.

Optical Properties

The haze, gloss and light transmission of UV-cured coated and uncoated PET films is shown in Table 9. PET films coated by film former Al -A4 exhibit similar values of haze and transmission as uncoated PET film, all in the range of 7.6-8.2 and 91.0-92.1, respectively. However, there is little reduction in gloss from 150 to the range of 120-130. In the coatings with the proteinoid prepolymers-film former mixtures P(KI) and P(EI) the haze values of the films increase and the gloss values decrease, but the transmission remains unchanged. Coating with P(KI)-film former mixture exhibits values of haze in the range of 9.2-20, and with the proteinoid P(EI) 8.7-14. It is possible that the increase in the haze is due to the low compatibility of the proteinoids with the PET film. The P(KF)-film former coatings exhibit low values of haze, similar to the haze of uncoated PET, in the range of 7.1-7.6. Overall, the haze, gloss and light transmission values of the coatings in all forms may be used for many applications requiring and relatively non-hazy and glossy films.

TABLE 9

| Coating type^{a} | Haze^{b} | Gloss^{b} | Transmission^{b} (%) |
|---|---|---|---|
| Uncoated PET | 7.4 ± 0.05 | 150 ± 2.5 | 91 ± 1.3 |
| A1 | 7.6 ± 0.17 | 120 ± 0.52 | 92 ± 1.5 |
| A2 | 7.7 ± 0.15 | 128 ± 1.22 | 91 ± 1.0 |
| A3 | 8.1 ± 5.13 | 120 ± 1.52 | 91 ± 1.8 |
| A4 | 8.2 ± 0.12 | 130 ± 2.15 | 91 ± 1.5 |
| P(KI)A1 | 9.2 ± 0.22 | 120 ± 4.5 | 91 ± 1.0 |
| P(KI)A2 | 10.8 ± 0.62 | 120 ± 11.6 | 91 ± 1.5 |
| P(KI)A3 | 11.7 ± 0.15 | 110 ± 5.12 | 91 ± 1.1 |
| P(KI)A4 | 20 ± 0.61 | 120 ± 5.32 | 91 ± 1.0 |
| P(KF)A1 | 7.1 ± 0.12 | 136 ± 1.42 | 91 ± 1.0 |
| P(KF)A2 | 7.2 ± 0.10 | 136 ± 1.00 | 91 ± 1.3 |
| P(KF)A3 | 7.6 ± 0.12 | 137 ± 2.60 | 91 ± 1.3 |
| P(KF)A4 | 7.3 ± 0.21 | 138 ± 3.46 | 90 ± 1.5 |
| P(EI)A1 | 8.7 ± 0.05 | 103 ± 3.21 | 92 ± 1.2 |
| P(EI)A2 | 10 ± 0.43 | 106 ± 2.08 | 91 ± 1.1 |
| P(EI)A3 | 11.7 ± 0.10 | 103 ± 7.12 | 91 ± 1.5 |
| P(EI)A4 | 14 ± 0.40 | 105 ± 3.72 | 91 ± 1.1 |

^{a}All samples refer to PET films coated with film former A1-A4 and proteinoid prepolymer-film former mixtures as specified;
^{b}each result represents an average of three measurements at three different areas of the film.

Fog Test

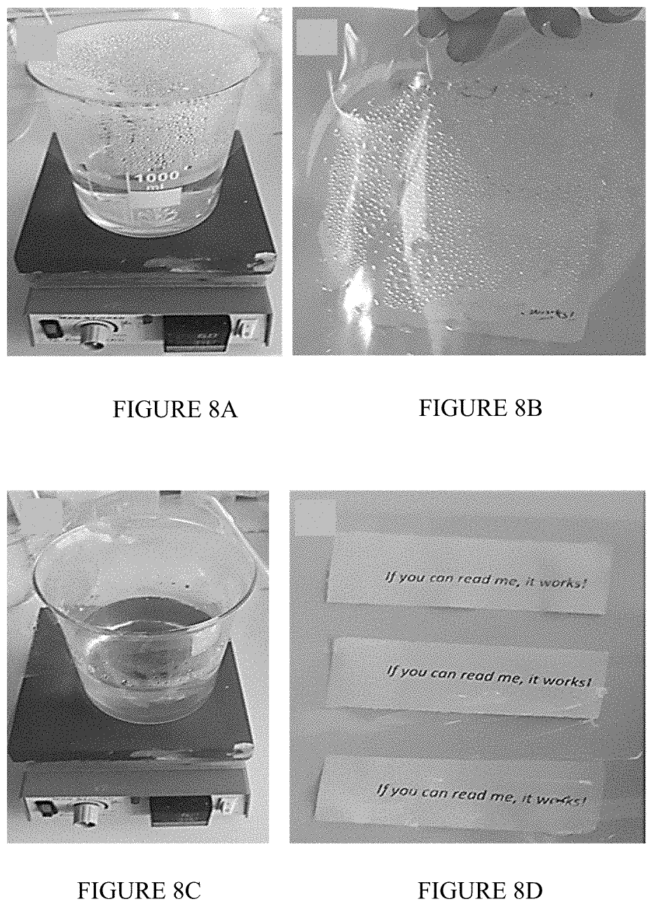

The coated films were tested in hot fog and cold fog tests, all the results were over 1 day of heating in 60° C. and cooling in 4° C., Table 10 and FIG. 8. FIG. 3 shows the range of optical visibility through the films, ranked as A-D.

Uncoated corona-treated PET films show poor visibility, ranked as D over 3 h, and 1 day with no change (FIG. 8A and B). Coating the corona-treated films with film former A1-A4 does not improve the visibility during the cold fog tests. However, in the hot fog test there was an improvement during the test, after 3 h in A2 and A3 the visibility was reranked as A/B. It can be assumed that the higher percent of PEG in the film former creates a better anti-fog film in a short time test. However, when coated by the proteinoid prepolymers-film former mixtures the visibility improves to rank A in hot fog and to rank A/B in cold fog. The film coated with P(EI) and P(KI) shows the best optical visibility, rank A, received within 5 min and remaining the same over 3 h in the hot fog test (FIG. 8C and D), despite the relatively high roughness that was showed earlier. Coating with P(KF) shows rank A only after 60 min and this result is surprising, due to the low roughness and good compatibility of P(KF) with the film compared to the P(EI) and P(KI). An improvement can also be seen after 1 day for coating with a high percent of PEG in the film former, Al shows rank C after 1 day but A3 and A4 show rank A/B. The film formers A2-A4 with the proteinoid prepolymers exhibited excellent anti-fog films stable even after 1 day of cooling or heating.

FIG. 8 illustrates the visual difference in the optical properties between uncoated and proteinoid coated PET films. As seen, the water spread into a continuous and uniform layer only on the proteinoid coated film (C, D) with rank A. Nevertheless, on uncoated PET films the water form tiny droplets on the surface that affects the clarity of the PET film (A, B).

TABLE 10

| | Hot test | | | | Cold test | | | |
|---|---|---|---|---|---|---|---|---|
| | Time | | | | Time | | | |
| | | 60 | 180 | | | 60 | 180 | |
| Sample^{a} | 5 min | min | min | 1 day | 5 min | min | min | 1 day |
| Uncoated | D | D | D | D | D | D | D | A/B |
| PET | | | | | | | | |
| A1 | D | C | C | C | D | D | D | A/B |
| A2 | D | C | B | B | D | D | D | A/B |
| A3 | D | C | A/B | A/B | D | D | D | A/B |
| A4 | D | C | A/B | A/B | D | D | D | A/B |
| P(KI)A1 | A | A | A | B/C | A | A | A | A/B |
| P(KI)A2 | A | A | A | A | A | A | A | A |
| P(KI)A3 | A | A | A | A | A | A | A | A |
| P(KI)A4 | A | A | A | A | A | A | A | A |
| P(KF)A1 | B | B | B | B/C | B/C | B/C | B/C | A |
| P(KF)A2 | B | B | B | B/C | B/C | B/C | B/C | A |
| P(KF)A3 | B | A/B | A | A | B/C | B/C | B/C | A |
| P(KF)A4 | A | A | A | A | B/C | B/C | B/C | A |
| P(EI)A1 | A | A | B/C | C | A | A | A | A |
| P(EI)A2 | A | A | A | B | A | A | A | A |
| P(EI)A3 | A | A | A | A | A | A | A | A |
| P(EI)A4 | A | A | A | A | A | A | A | A |

^{a}All samples refer to PET films coated with film former A1-A4 and proteinoid prepolymer-film former mixtures as specified.

Similar results to those described in the manuscript were obtained by substituting in the UV curing procedure the proteinoid prepolymers for proteinoids only. This can be explained by the huge excess of the crosslinker monomer (PEGDA) relative to the proteinoids, so that mixing the PEGDA with the proteinoids under slight basic conditions will produce anyhow proteinoids containing activated double bonds.

In addition, the PEGDA can be replaced by similar diacrylates containing different io length of the PEG or by dimethacrylate PEG.

1. (canceled)

2. A composition comprising: (i) at least one proteinoid compound comprising a polymeric backbone, wherein said polymeric backbone comprises monomeric units, each of said monomeric units being derived from an amino acid, and wherein said polymeric backbone is characterized by a molecular weight (Mw) of at least 5,000 Da, and (ii) wherein any one of:
at least one proteinoid compound further encapsulates or is attached to at least one antifogging agents;
the composition further comprises a substrate having incorporated in and/or on a portion thereof at least one proteinoid compound, optionally wherein the proteinoid compound encapsulates or is attached to at least one antifogging agent; and
the composition further comprises a crosslinker, and wherein the proteinoid compound comprises at least one activated double bond, at least one primary amine, or a combination thereof.

3. (canceled)

4. The composition of claim 2, wherein the composition comprises a crosslinker selected from: (i) a crosslinker comprising an acrylate polymer (ii) an acrylate polymer having an average molecular weight in the range of 200 Da to 1000 Da; (iii) a crosslinker comprising a diacrylate monomer, triacrvlate monomer or a combination thereof.

5. (canceled)

6. (canceled)

7. The composition of claim 2, wherein the composition comprises a crosslinker and further comprising a photo-initiator.

8. The composition of claim 2, wherein said amino acid is, in each instance, selected from the group consisting of: Glu, Lys, Asp, Arg, Tyr, His, Ala, Ser, Trp and Phe, Ile, and p-amino benzoic acid.

9. The composition of claim 2, wherein said polymeric backbone comprises Glu or Lys.

10. The composition of claim 9, wherein said polymeric backbone further comprises Phe.

11. The composition of claim 9, wherein said polymeric backbone further comprises Glu or Lys, and Phe and/or Ile.

12. The composition of claim 9, wherein said Glu or Lys is at least 20%, by weight, of said polymeric backbone.

13. The composition of claim 2, wherein said at least one proteinoid compound is in form of a particle.

14. The composition of claim 2, comprising a plurality of said proteinoid compounds.

15. The composition of claim 14, wherein at least 80% of the plurality of said proteinoid compounds are characterized by a dispersity index (D) value of less than 1.5.

16. (canceled)

17. The composition of claim 2, wherein said at least one antifogging agent is selected from the group consisting of: sorbitan monooleate (SMO), glycerol monooleate (GMO), glyceryl monostearate, sorbitan monolaurate, sorbitan monostearate, sorbitan trioleate, sorbitan polyethylene oxide, sorbitan monopalmitate, polyoxyethylene sorbitan monolaurate, fatty acid ester of sucrose and any combination thereof.

18. The composition of claim 2, wherein said substrate is selected from (i) a polymeric material, optionally wherein said polymeric material is selected from the group consisting of polypropylene (PP), polycarbonate (VC), polyethylene high-density polyethylene (HDPE) polyester (PRE) polyethyl terepthalate (PET) polyvinyl chloride (PVC), polystyrene, polymethvl methacrylate and poiytetrafluoroethylene (PIFE, Teflon®); (ii) a substrate further comprising on at least a portion thereof an adhesive material, wherein said at least one proteinoid compound is deposited on, or incorporated in at least one portion of said adhesive material.

19. (canceled)

20. (canceled)

21. (canceled)

22. The composition of claim 18, wherein said adhesive material is imine.

23. The composition of any claim 2, being characterized by a liquid contact angle of less than 100°.

24. (canceled)

25. (canceled)

26. The composition of claim 2, being characterized by a RMS roughness having a value of at least 30% lower than a RMS roughness of a portion of a control surface, said control surface not having deposited thereon said proteinoid compound.

27. An article-of-manufacturing comprising the composition of claim 2.

28. The article-of-manufacturing of claim 27, being selected from the group consisting of: sealing part, for example, O-rings, article having a corrosivable surface, a construction element, and an optical article.

29. (canceled)

30. A method of reducing water contact angle on a surface of a substrate, the method comprising applying a composition according to claim 2 to said surface.

31. The method of claim 30, further comprising the step of UV curing said surface.
